(19) United States
(12) Patent Application Publication
(10) Pub. No.: US 2025/0137689 A1
(43) Pub. Date: May 1, 2025

(54) PREDICTIVE CONTROL FOR HEAT TRANSFER TO FLUIDS

(71) Applicant: ALTUS THERMAL, INC., Melrose, MA (US)

(72) Inventors: Michael Rigney, Melrose, MA (US); Michael Ting, Boston, MA (US)

(21) Appl. No.: 18/834,059

(22) PCT Filed: Mar. 24, 2023
(86) PCT No.: PCT/US2023/016238

§ 371 Date: Jul. 29, 2024

Related U.S. Application Data
(60) Provisional application No. 63/323,394, filed on Mar. 24, 2022.
(60) Provisional application No. 63/323,400, filed on Mar. 24, 2022.

(51) Int. Cl. F24H 15/152; F24H 4/04; F24H 15/219; F24H 15/262; F24H 15/277; F24H 15/281; F24H 15/315; F24H 15/38; F24H 15/421

(52) U.S. Cl. CPC F24H 15/152; F24H 15/219; F24H 15/262; F24H 15/277; F24H 15/281; F24H 15/315; F24H 15/38; F24H 15/421; F24H 4/04

(57) ABSTRACT

Predictive controllers are disclosed which provide, among other things, efficient strategics for controlling heat transfer to or from a liquid. A method and system are disclosed that includes receiving input information including any or all of user preferences, energy price information, solar information, and GHG intensity information, determining with the predictive controller settings information to provide one or both of fluid temperature set points and compressor settings of a heat pump system and heating the fluid in response to the settings information to provide hot fluid according to the user preferences and to achieve the economic efficiencies.

### RELATED APPLICATIONS

This application claims the benefit of U.S. Provisional Patent Application Ser. No. 63/323,394, titled PREDICTIVE CONTROL FOR HEAT TRANSFER TO LIQUIDS, filed on Mar. 24, 2022, and U.S. Provisional Patent Application Ser. No. 63/323,400, titled PREDICTIVE CONTROL COUPLED WITH TEMPERING DEVICE, filed on Mar. 24, 2022,each of which are hereby incorporated by reference in their entirety for all purposes.

### FIELD OF INVENTION This disclosure relates to a method and system for controlling heat transfer to a fluid, more specifically a predictive controller for a heat pump hot water heater system.

### BACKGROUND

According to the U.S. Energy Information Agency, buildings account for approximately 28% of total U.S. end-use energy consumption and 39% of total U.S. energy consumption.

As efforts to decarbonize the building sector via electrification accelerate, electric heat pumps are increasingly being used for heating domestic hot water and for heating buildings, via both forced air and hydronic heating systems. For cooling buildings, heat pumps (a.k.a air conditioners) continue to be the dominant technology. Related to this decarbonization trend, intermittent renewable energy sources (wind, solar) are providing an increasing proportion of electricity on the grid. Distributed generation is also increasing in both residential and consumer buildings. Average electricity prices rose 9% and 11% in residential and commercial markets, respectively from December 2021 to December 2022, and electricity pricing is becoming more varied.

Current methods and systems for operating heat pump systems to heat fluids under these conditions suffer from limitations.

### SUMMARY

Aspects and embodiments are directed to a method and system for controlling heat transfer to a fluid. More specifically, aspects and embodiments are directed to a method and system for heating fluid with a predictive controller configured to achieve user preferences and energy economic efficiencies. More specifically, aspects and embodiments are directed to a method and system for heating fluid with a model predictive controller to achieve user preferences and energy economic efficiencies. More specifically, aspects and embodiments are directed to a predictive controller for a heat pump system. More specifically, aspects and embodiments are directed to a predictive controller for a heat pump hot water system.

In one aspect, a method for heating fluid with a predictive controller is disclosed. The method comprises determining with the model predictive controller an optimized fluid temperature point so as to achieve energy usage optimization; heating the fluid utilizing a variable speed compressor to the optimized fluid temperature set-point; repeatedly determining with the model predictive control function the optimized fluid temperature set-point and repeatedly controlling the variable speed compressor to heat the fluid to the optimized fluid temperature set-point so as to optimize the energy usage.

In one aspect, a method for heating fluid with a predictive controller configured to achieve user preferences and energy economic efficiencies is disclosed. The method comprises receiving input information including all of user preferences, energy price information, solar information, and GHG intensity information, determining with the predictive controller settings information to provide one or both of fluid temperature set points and compressor settings of a heat pump system in order to achieve the user preferences and energy economic efficiencies, heating the fluid in response to the settings information to provide hot fluid according to the user preferences and to achieve the economic efficiencies, and continually determining with the predictive controller the settings information and heating the fluid in response to the settings information so as to continually provide the hot fluid according to the user preferences and to achieve the economic efficiencies.

In one aspect, a method for heating fluid with a predictive controller configured to achieve user preferences and energy economic efficiencies is disclosed. The method comprises receiving input information including all of user preferences, energy price information, solar forecasting information, and GHG intensity information, determining future water demand information with a usage prediction model, determining with the predictive controller settings information to provide one or both of water temperature set points and compressor settings of a heat pump water heater in order to achieve the user preferences and energy economic efficiencies, heating the water in response to the settings information to provide hot water according to the user preferences and to achieve the economic efficiencies, and continually determining with the predictive controller the settings information and heating the water in response to the settings information so as to continually provide the hot water according to the user preferences and to achieve the economic efficiencies.

One or more aspects and embodiments of the method include the predictive controller is a model predictive controller.

In one aspect, a heat pump system for heating fluid with a predictive controller configured to achieve user preferences and energy economic efficiencies is disclosed. The heat pump system includes any or all of a fluid storage tank, a fluid inlet, a fluid outlet, a heat pump sub assembly comprising a first heat exchanger in thermal communication with any of air, fluid and ground from and to which heat is being transferred, a second heat exchanger in thermal communication with the fluid storage tank, a variable speed compressor, a refrigerant heat transfer medium, one or more heating elements, and a database for storing input information. The heat pump system system further comprises the database for receiving input information including any or all of user preferences, energy price information, solar information, and GHG intensity information and for storing the input information in the database, a usage predictive model that receives the input information and determines future fluid demand information, a predictive controller that receives the future fluid demand information and the input information and that is configured to determine and provide settings information that includes one or both of fluid temperature set points and variable compressor speed set points of the variable speed compressor so as to heat the fluid so as to achieve the user preferences and energy economic efficiencies; and wherein the predictive controller is further configured to continually determine the settings information and heat the fluid in response to the settings information so as to continually provide the hot fluid according to the user preferences and to achieve the economic efficiencies.

In one aspect, a heat pump system for heating fluid with a predictive controller configured to achieve user preferences and energy economic efficiencies is disclosed. The heat pump system includes any or all of a water storage tank, a water inlet, a water outlet, a heat pump sub assembly comprising a first heat exchanger in thermal communication with any of air, water and ground from and to which heat is being transferred, a second heat exchanger in thermal communication with the water storage tank, a variable speed compressor, a refrigerant heat transfer medium, one or more heating elements, and a database for storing input information. The heat pump water heater system further comprises the database having an input for receiving input information including any or all of user preferences, energy price information, solar forecasting information, and GHG intensity information and for storing the input information in the database, a usage predictive model that receives the input information and determines future water demand information, a predictive controller that receives the future water demand information and the input information and that is configured to determine and provide settings information that includes one or both of water temperature set points and variable compressor speed set points of the variable speed compressor so as to heat the water so as to achieve the user preferences and energy economic efficiencies, and wherein the predictive controller is further configured to continually determine the settings information and heat the water in response to the settings information so as to continually provide the hot water according to the user preferences and to achieve the economic efficiencies.

One or more aspects and embodiments of the heat pump system include the predictive controller is a model predictive controller.

In one aspect, one or more non-transitory computer-readable media storing instructions that, when executed by one or more processors, cause the one or more processors to perform operations to heat fluid with a predictive controller configured to achieve user preferences and energy economic efficiencies is disclosed. The operations include receiving input information including any or all of user preferences, energy price information, solar information, and GHG intensity information, determining future fluid demand information with a usage prediction model, determining settings information with a predictive controller to provide one or both of fluid temperature set points and variable compressor speed set points of a variable speed compressor of the heat pump system in order to achieve the user preferences and energy economic efficiencies, heating the fluid in response to the settings information to provide hot fluid according to the user preferences and to achieve the economic efficiencies, and continually determining the settings information with the predictive controller and instructions to heat the fluid in response to the settings information so as to continually provide the hot fluid according to the user preferences and to achieve the economic efficiencies.

In one aspect, one or more non-transitory computer-readable media storing instructions that, when executed by one or more processors, cause the one or more processors to perform operations to heat fluid with a predictive controller configured to achieve user preferences and energy economic efficiencies is disclosed. The operations include receiving input information including any or all of user preferences, energy price information, solar forecasting information, and GHG intensity information, determining future water demand information with a usage prediction model, determining settings information with a predictive controller to provide one or both of water temperature set points and variable compressor speed set points of a variable speed compressor of the heat pump water heater in order to achieve the user preferences and energy economic efficiencies, heating the water in response to the settings information to provide hot water according to the user preferences and to achieve the economic efficiencies, and continually determine the settings information with the predictive controller and instructions to heat the water in response to the settings information so as to continually provide the hot water according to the user preferences and to achieve the economic efficiencies.

One or more aspects and embodiments of the computer-readable include instructions that cause the one or more processors to perform operations comprising providing the settings information with a model predictive controller.

In one aspect, a method for heating fluid with a predictive controller configured to achieve user preferences and energy economic efficiencies is disclosed. The method comprises receiving heat pump system information and input information including any or all of user preferences, energy price information, solar information, and GHG intensity information, determining usage prediction information including future fluid demand information with a usage prediction model, determining with a model predictive controller multiple potential outcomes for heat pump system performance with a time-varying model of the heat pump system that tests multiple potential settings of one or both of fluid temperature set point and variable speed compressor set point over a defined time period (prediction horizon) using the heat pump system information, the input information and the usage prediction information, and selecting preferred settings information including one or both of the preferred fluid temperature set points and preferred variable compressor speed set points using an objective function that uses the user preferences and the input information, heating the fluid in response to the preferred settings information for a defined period of time (control horizon) to provide the heated fluid according to the user preferences and to achieve the economic efficiencies, continually determining with the model predictive controller the preferred settings information for each control horizon and heating the fluid in response to the preferred settings information so as to continually provide the fluid according to the user preferences and to achieve the economic efficiencies.

One or more aspects and embodiments of the method include the model predictive controller is further configured to provide the preferred settings information to optimize any of or any combination of user comfort, cost reduction, greenhouse gas emissions reduction, and distributed energy system synchronization.

One or more aspects and embodiments of the method include the objective function uses gradient descent to select the preferred settings.

One or more aspects and embodiments of the method include the objective function includes any of criteria weighting, criteria forced ranking, criteria normalizing to an absolute value, or criteria normalizing for one or more scenarios.

One or more aspects and embodiments of the method include the model predictive controller is configured to enable providing the preferred settings information to optimize the user preferences.

One or more aspects and embodiments of the method include the model predictive controller is configured to enable providing the preferred settings information to optimize the economic efficiencies.

One or more aspects and embodiments of the method include the model predictive controller is configured so that the user can provide instructions to not use the solar information to determine the preferred settings information.

One or more aspects and embodiments of the method include the model predictive controller is configured so that the user can provide instructions to not use the GHG intensity information to determine the preferred settings information.

One or more aspects and embodiments of the method include the energy price information includes flat rate pricing information and the model predictive controller is configured to not use the flat rate energy price information to determine the preferred settings information.

One or more aspects and embodiments of the method include the preferred settings information includes instructions to a compressor controller to modify a compressor partial loading and timing.

One or more aspects and embodiments of the method include the preferred settings information includes reactive controller preferred settings information to be provided to a reactive controller that also receives the heat pump system information so that the reactive controller controls one or both of the variable speed compressor and one or more heating elements to heat the fluid according to the reactive controller preferred settings information.

One or more aspects and embodiments of the method include the heat pump system information includes fluid flow information provided by a fluid flow meter, and wherein the usage prediction model uses the fluid information to provide the usage prediction information.

One or more aspects and embodiments of the method include the input information further comprises any of weather information, occupancy information, information from other building devices including any of thermostats, refrigerators, HVAC equipment, lights, smart building and management systems, and information from other buildings with similar usage profiles, and wherein the usage prediction model uses the input information to determine the usage prediction information.

One or more aspects and embodiments of the method include heating the fluid with one or more resistive heating elements.

One or more aspects and embodiments of the method include the reactive controller preferred settings information includes any of fluid temperature setpoints, compressor speed setpoints, fractional weighting between temperature sensors, and dead band offsets.

One or more aspects and embodiments of the method include the reactive controller uses any of the fluid temperature setpoints and the compressor speed set points, proportional-integral-derivative (PID) control, or other control methods to turn on and off the variable speed compressor and/or the one or more heating elements to heat the fluid.

One or more aspects and embodiments of the method include controlling an amount of mixing of the hot fluid with a source of fluid with a mixing valve so as to control an output fluid temperature of the hot fluid.

One or more aspects and embodiments of the method include the input information further includes weather-related information and wherein the model predictive controller is further configured to provide the preferred settings information additionally in response to the weather-related information.

One or more aspects and embodiments of the method include the model predictive controller is configured so that the user can provide instructions to not use the weather-related information to determine the preferred settings information.

One or more aspects and embodiments of the method include the solar information includes one or both of output prediction information or a real-time output signal from a home solar system or other data source.

One or more aspects and embodiments of the method include the input information further includes historical hot fluid usage data and the future fluid demand information and/or the preferred settings information is additionally determined in response to the historical hot fluid usage data.

One or more aspects and embodiments of the method include the historical hot fluid usage data includes usage information that is summed or averaged over segments of time and duration and the segments are separated to distinguish between any of day of the week, weekday, weekend, holiday, non-holiday, month, and season.

One or more aspects and embodiments of the method include the input information further comprises any of occupancy information, information from other building thermostats, refrigerators, HVAC equipment, lights, smart building and management systems, and information from other buildings with similar usage profiles.

One or more aspects and embodiments of the method include the user preferences include periods of time during which heat pump operation is not desirable.

One or more aspects and embodiments of the method include receiving input information further includes receiving any of inlet fluid temperature information, fluid flow information, and present usage information.

One or more aspects and embodiments of the method include the present usage information includes any of current fluid temperature, volume of the fluid, and volumetric flow rate.

One or more aspects and embodiments of the method include the usage prediction model includes a rolling average of resource usage over a plurality of time bins throughout the day and that are separated to distinguish between days of the week, weekday and weekend usage patterns.

One or more aspects and embodiments of the method include the usage prediction model includes a rolling average of resource usage over a plurality of time bins throughout the day and that are separated to distinguish between holidays and non-holidays, month, and season.

One or more aspects and embodiments of the method include the usage prediction model includes any of autoregressive models, autoregressive integrated moving average models, seasonal autoregressive integrated moving average, exponential smoothing, Prophet, Long Short-Term Memory (LSTM), DeepAR, N-Beats, Temporal Fusion Transformer, Multi-Layer Perceptron, Bayesian Neural Network, Radial Basis Functions Neural Network, General Regression Neural Network, K-Nearest Neighbor Regression Neural Network, CART Regression Trees, Support Vector Regression, and Gaussian Processes.

One or more aspects and embodiments of the method include the input information includes compressor performance information including any of energy consumption and thermal output capacity (heating or cooling) as a function of heat source temperature, heat source humidity, temperature of the fluid to be heated or cooled, and partial load percentage of the compressor.

In one aspect, a heat pump system for heating fluid with a predictive controller configured to achieve user preferences and energy economic efficiencies is disclosed. The heat pump system includes any or all of a fluid storage tank, a fluid inlet, a fluid outlet, a heat pump sub assembly comprising a first heat exchanger in thermal communication with any of air, fluid and ground from and to which heat is being transferred, a second heat exchanger in thermal communication with the fluid storage tank, a variable speed compressor, a refrigerant heat transfer medium, one or more heating elements, and a database for storing input information. The heat pump system further comprises the database having an input for receiving heat pump system information and input information including any or all of user preferences, energy price information, solar information, and GHG intensity information and for storing the input information in the database, a usage predictive model that determines usage prediction information including future fluid demand information, a model predictive controller that receives the heat pump system information, the input information and the usage prediction information, and that is configured to determine multiple potential outcomes for heat pump system performance with a time-varying physics-based model of the heat pump system that tests multiple potential settings of one or both of fluid temperature set point and variable speed compressor set point over a defined time period (prediction horizon) and that selects preferred settings information including one or both of the preferred fluid temperature set points and preferred variable compressor speed set points using an objective function that uses the user preferences and the input information, and wherein the model predictive controller is further configured to continually determine the preferred settings information for a defined period of time (control horizon) to heat the fluid in response to the preferred settings information so as to continually provide the hot fluid according to the user preferences and to achieve the economic efficiencies.

One or more aspects and embodiments of the heat pump system include the model predictive controller is further configured to provide the preferred settings information to optimize any of or any combination of user comfort, cost reduction, greenhouse gas emissions reduction, and distributed energy system synchronization.

One or more aspects and embodiments of the heat pump system include the objective function is configured to use gradient descent to select the preferred settings.

One or more aspects and embodiments of the heat pump system include the objective function includes any of criteria weighting, criteria forced ranking, criteria normalizing to an absolute value, or criteria normalizing for one or more scenarios.

One or more aspects and embodiments of the heat pump system include the model predictive controller is configured to enable providing the preferred settings information to optimize the user preferences.

One or more aspects and embodiments of the heat pump system include the model predictive controller is configured to enable providing the preferred settings information to optimize the economic efficiencies.

One or more aspects and embodiments of the heat pump system include the model predictive controller is configured so that the user can provide instructions to not use the solar information to determine the preferred settings information.

One or more aspects and embodiments of the heat pump system include the model predictive controller is configured so that the user can provide instructions to not use the GHG intensity information to determine the preferred settings information.

One or more aspects and embodiments of the heat pump system include the energy price information includes flat rate pricing information and the model predictive controller is configured to not use the flat rate energy price information to determine the preferred settings information.

One or more aspects and embodiments of the heat pump system include the preferred settings information includes instructions to a compressor controller to modify a compressor partial loading and timing.

One or more aspects and embodiments of the heat pump system include a reactive controller that also receives the heat pump system information, wherein the preferred settings information includes reactive controller preferred settings information to be provided to the reactive controller so that the reactive controller controls one or both of the variable speed compressor and the one or more heating elements to heat the fluid according to the reactive controller preferred settings information.

One or more aspects and embodiments of the heat pump system include a fluid flow meter that provides fluid flow information, and wherein the usage prediction model uses the fluid information to provide the usage prediction information.

One or more aspects and embodiments of the heat pump system include the input information further comprises any of weather information, occupancy information, information from other building devices including any of thermostats, refrigerators, HVAC equipment, lights, smart building and management systems, and information from other buildings with similar usage profiles, and wherein the usage prediction model uses the input information to determine the usage prediction information.

One or more aspects and embodiments of the heat pump system include the one or more heating elements include one or more resistive heating elements.

One or more aspects and embodiments of the heat pump system include the reactive controller preferred settings information includes any of the fluid temperature setpoints, the compressor speed setpoints, fractional weighting between temperature sensors, and dead band offsets.

One or more aspects and embodiments of the heat pump system include the reactive controller uses any of the fluid temperature setpoints and the compressor speed set points, proportional-integral-derivative (PID) control, or other control methods to turn on and off the variable speed compressor and/or the one or more heating elements to heat the fluid.

One or more aspects and embodiments of the heat pump system include a mixing valve that mixes an amount of the hot fluid with a source of fluid so as to provide an output fluid temperature of the hot fluid.

One or more aspects and embodiments of the heat pump system include the input information further includes weather-related information and wherein the model predictive controller is further configured to provide the preferred settings information additionally in response to the weather-related information.

One or more aspects and embodiments of the heat pump system include the model predictive controller is further configured so that the user can provide instructions to not use the weather-related information to determine the preferred settings information.

One or more aspects and embodiments of the heat pump system include the solar information includes one or both of output prediction information or a real-time output signal from a home solar system or other data source.

One or more aspects and embodiments of the heat pump system include the input information further includes historical hot fluid usage data and the future fluid demand information and/or the preferred settings information is additionally determined in response to the historical hot fluid usage data.

One or more aspects and embodiments of the heat pump system include the historical hot fluid usage data includes usage information that is summed or averaged over segments of time and duration and the segments are separated to distinguish between any of day of the week, weekday, weekend, holiday, non-holiday, month, and season.

One or more aspects and embodiments of the heat pump system include the input information further comprises any of occupancy information, information from other building thermostats, refrigerators, HVAC equipment, lights, smart building and management systems, and information from other buildings with similar usage profiles. One or more aspects and embodiments of the heat pump system include the user preferences include periods of time during which heat pump operation is not desirable. One or more aspects and embodiments of the heat pump system include at least one sensor measuring status data from at least one of a plurality of apparatus of the heat pump system and wherein the database is configured to store the status data.

One or more aspects and embodiments of the heat pump system include any or all of a fan, a condensate line, and an expansion valve.

One or more aspects and embodiments of the heat pump system include the input information further includes any of inlet fluid temperature information, fluid flow information, and present usage information.

One or more aspects and embodiments of the heat pump system include the present usage information includes any of current fluid temperature, volume of the fluid, and volumetric flow rate.

One or more aspects and embodiments of the heat pump system include the usage prediction model includes a rolling average of resource usage over a plurality of time bins throughout the day and that are separated to distinguish between days of the week, weekday and weekend usage patterns.

One or more aspects and embodiments of the heat pump system include the usage prediction model includes a rolling average of resource usage over a plurality of time bins throughout the day and that are separated to distinguish between holidays and non-holidays, month, and season.

One or more aspects and embodiments of the heat pump system include the usage prediction model includes any of autoregressive models, autoregressive integrated moving average models, seasonal autoregressive integrated moving average, exponential smoothing, Prophet, Long Short-Term Memory (LSTM), DeepAR, N-Beats, Temporal Fusion Transformer, Multi-Layer Perceptron, Bayesian Neural Network, Radial Basis Functions Neural Network, General Regression Neural Network, K-Nearest Neighbor Regression Neural Network, CART Regression Trees, Support Vector Regression, and Gaussian Processes.

One or more aspects and embodiments of the heat pump system include the input information includes compressor performance information including any of energy consumption and thermal output capacity (heating or cooling) as a function of heat source temperature, heat source humidity, temperature of the fluid to be heated or cooled, and partial load percentage of the compressor.

One or more aspects and embodiments of the method and system include the compressor performance information includes any of compressor setting information provided by a multidimensional lookup table comprising input variables including the temperature of the fluid to be heated or cooled, target fluid temperature, heat source temperature, heat source humidity, and the duration of allowable heating, and the usage prediction model comprises a lookup function that uses the compressor performance information to provide output values including the compressor partial load setting and the duration for which each setting shall be maintained during the heating cycle.

One or more aspects and embodiments of the method and system include the input information further comprises reactive control loop information including any of temperature sensor data, flow meter data, electric element energy usage data, and heat pump system data.

One or more aspects and embodiments of the method and system include the settings information includes providing control information to one or more fans, pumps, expansion valves, mixing valves, and heating elements.

One or more aspects and embodiments of the method and system include the usage prediction model also receives as input a location within the home where the heat pump system is installed, whether that space is typically occupied, and when that space is typically occupied.

One or more aspects and embodiments of the method and system include the usage prediction model receives comfort preferences of the occupants including relative importance of comfort vs. savings of other parameters including cost, energy use, and carbon intensity.

One or more aspects and embodiments of the method and system include the usage prediction model receives a control signal indicating that the system should temporarily raise the setpoint temperature of the unit above the nominal setpoint temperature in advance of anticipated occupancy.

One or more aspects and embodiments of the method and system include the model predictive controller provides setting information to turn on heat pump heating in order to add additional thermal capacity to the tank during unoccupied hours in order to minimize comfort disruptions to the occupants.

One or more aspects and embodiments of the method and system include the model predictive controller provides settings information to turn off the heating elements or the variable speed compressor when the desired elevated setpoint temperature has been reached, and/or prior to the anticipated start of occupancy.

One or more aspects and embodiments of the method and system include the model predictive controller reduces the temperature setpoints back to a nominal value or a reduced value determined by the model predictive controller.

One or more aspects and embodiments of the method and system include the usage prediction model receives a signal indicating that the system should temporarily supersede the reactive controller to utilize the resistive element(s) rather than the heat pump in order to minimize occupant discomfort due to unwanted cooling and/or dehumidification.

One or more aspects and embodiments of the method and system include that the predictive controller is a reinforcement learning predictive controller that utilizes reinforcement learning.

One or more aspects and embodiments of the method and system include that both the predictive controller and the resource usage prediction or predictive model is a reinforcement learning predictive controller that utilizes reinforcement learning.

In one aspect, one or more non-transitory computer-readable media storing instructions that, when executed by one or more processors, cause the one or more processors to perform operations to heat fluid with a predictive controller configured to achieve user preferences and energy economic efficiencies is disclosed. The operations include receiving heat pump system information and input information including any or all of user preferences, energy price information, solar information, and GHG intensity information, determining usage prediction information including future fluid demand information with a usage prediction model, determining with a model predictive controller multiple potential outcomes for heat pump system performance with a time-varying physics-based model of the heat pump system that tests multiple potential settings of one or both of fluid temperature set point and variable speed compressor set point over a defined time period (prediction horizon) using the heat pump system information, the input information and the usage prediction information, and selecting preferred settings information including one or both of the preferred fluid temperature set points and preferred variable compressor speed set points using an objective function that uses the user preferences and the input information, heating the fluid in response to the preferred settings information for a defined period of time (control horizon) to provide the heated fluid according to the user preferences and to achieve the economic efficiencies, and continually determining with the model predictive controller the preferred settings information for each control horizon and heating the fluid in response to the preferred settings information so as to continually provide the fluid according to the user preferences and to achieve the economic efficiencies.

One or more aspects and embodiments of the computer-readable include instructions that cause the one or more processors to perform operations comprising providing the preferred settings information to optimize any of or any combination of user comfort, cost reduction, greenhouse gas emissions reduction, and distributed energy system synchronization.

One or more aspects and embodiments of the computer-readable include instructions that cause the one or more processors to perform operations comprising the objective function uses gradient descent to select the preferred settings.

One or more aspects and embodiments of the computer-readable include instructions that cause the one or more processors to perform operations comprising the objective function includes any of criteria weighting, criteria forced ranking, criteria normalizing to an absolute value, or criteria normalizing for one or more scenarios.

One or more aspects and embodiments of the computer-readable include instructions that cause the one or more processors to perform operations comprising providing the preferred settings information to optimize the user preferences.

One or more aspects and embodiments of the computer-readable include instructions that cause the one or more processors to perform operations comprising providing the preferred settings information to optimize the economic efficiencies.

One or more aspects and embodiments of the computer-readable include instructions that cause the one or more processors to perform operations comprising enabling the user to provide instructions to not use the solar information to determine the preferred settings information.

One or more aspects and embodiments of the computer-readable include instructions that cause the one or more processors to perform operations comprising enabling the user to provide instructions to not use the GHG intensity information to determine the preferred settings information.

One or more aspects and embodiments of the computer-readable include instructions that cause the one or more processors to perform operations comprising receiving the energy price information including flat rate pricing information and not using the flat rate energy price information to determine the preferred settings information.

One or more aspects and embodiments of the computer-readable include instructions that cause the one or more processors to perform operations comprising providing instructions to a compressor controller to modify a compressor partial loading and timing.

One or more aspects and embodiments of the computer-readable include instructions that cause the one or more processors to perform operations comprising providing reactive controller preferred settings information to a reactive controller that also receives heat pump system information so that the reactive controller controls one or both of the variable speed compressor and one or more heating elements to heat the fluid according to the reactive controller preferred settings information.

One or more aspects and embodiments of the computer-readable include instructions that cause the one or more processors to perform operations comprising receiving fluid flow information provided by a fluid flow meter and wherein using the fluid flow information to provide the usage prediction information.

One or more aspects and embodiments of the computer-readable include instructions that cause the one or more processors to perform operations comprising receiving the input information further comprising any of weather information, occupancy information, information from other building devices including any of thermostats, refrigerators, HVAC equipment, lights, smart building and management systems, and information from other buildings with similar usage profiles, and wherein the usage prediction model uses the input information to determine the usage prediction information.

One or more aspects and embodiments of the computer-readable include instructions that cause the one or more processors to perform operations comprising heating the fluid with one or more resistive heating elements.

One or more aspects and embodiments of the computer-readable include instructions that cause the one or more processors to perform operations comprising providing the reactive controller settings information including any of fluid temperature setpoints, compressor speed setpoints, fractional weighting between temperature sensors, and dead band offsets.

One or more aspects and embodiments of the computer-readable include instructions that cause the one or more processors to perform operations comprising using any of the fluid temperature setpoints and the preferred compressor speed set points, proportional-integral-derivative (PID) control, or other control methods to turn on and off the variable speed compressor and/or the one or more heating elements to heat the fluid.

One or more aspects and embodiments of the computer-readable include instructions that cause the one or more processors to perform operations comprising mixing of the hot fluid with a source of fluid with a mixing valve so as to control an output fluid temperature of the hot fluid.

One or more aspects and embodiments of the computer-readable include instructions that cause the one or more processors to perform operations comprising receiving weather-related information and providing the preferred settings information additionally in response to the weather-related information.

One or more aspects and embodiments of the computer-readable include instructions that cause the one or more processors to perform operations comprising enabling a user to provide instructions to not use the weather-related information to determine the preferred settings information.

One or more aspects and embodiments of the computer-readable include instructions that cause the one or more processors to perform operations comprising receiving the solar information including one or both of output prediction information or a real-time output signal from a home solar system or other data source.

One or more aspects and embodiments of the computer-readable include instructions that cause the one or more processors to perform operations comprising receiving historical hot fluid usage data and determining the future fluid demand information and/or the preferred settings information in response to the historical hot fluid usage data.

One or more aspects and embodiments of the computer-readable include instructions that cause the one or more processors to perform operations comprising receiving usage information that is summed or averaged over segments of time and duration and the segments are separated to distinguish between any of day of the week, weekday, weekend, holiday, non-holiday, month, and season.

One or more aspects and embodiments of the computer-readable include instructions that cause the one or more processors to perform operations comprising receiving any of occupancy information, information from other building thermostats, refrigerators, HVAC equipment, lights, smart building and management systems, and information from other buildings with similar usage profiles.

One or more aspects and embodiments of the computer-readable include instructions that cause the one or more processors to perform operations comprising receiving user preferences including periods of time during which heat pump operation is not desirable.

One or more aspects and embodiments of the computer-readable include instructions that cause the one or more processors to perform operations comprising receiving any of inlet fluid temperature information, fluid flow information, and present usage information.

One or more aspects and embodiments of the computer-readable include instructions that cause the one or more processors to perform operations comprising the present usage information including any of current fluid temperature, volume of the fluid, and volumetric flow rate.

One or more aspects and embodiments of the computer-readable include instructions that cause the one or more processors to perform operations comprising the usage prediction model including a rolling average of resource usage over a plurality of time bins throughout the day and that are separated to distinguish between days of the week, weekday and weekend usage patterns.

One or more aspects and embodiments of the computer-readable include instructions that cause the one or more processors to perform operations comprising the usage prediction model including a rolling average of resource usage over a plurality of time bins throughout the day and that are separated to distinguish between holidays and non-holidays, month, and season.

One or more aspects and embodiments of the computer-readable include instructions that cause the one or more processors to perform operations comprising the usage prediction model including any of autoregressive models, autoregressive integrated moving average models, seasonal autoregressive integrated moving average, exponential smoothing, Prophet, Long Short-Term Memory (LSTM), DeepAR, N-Beats, Temporal Fusion Transformer, Multi-Layer Perceptron, Bayesian Neural Network, Radial Basis Functions Neural Network, General Regression Neural Network, K-Nearest Neighbor Regression Neural Network, CART Regression Trees, Support Vector Regression, and Gaussian Processes

One or more aspects and embodiments of the computer-readable include instructions that cause the one or more processors to perform operations comprising the input information including compressor performance information including any of energy consumption and thermal output capacity (heating or cooling) as a function of heat source temperature, heat source humidity, temperature of the fluid to be heated or cooled, and partial load percentage of the compressor.

In one aspect, a method for heating fluid with a predictive controller configured to achieve user preferences and energy economic efficiencies is disclosed. The method comprises receiving input information including all of user preferences, energy price information, solar information, and GHG intensity information, determining future fluid demand information with a usage prediction model, determining with the predictive controller settings information to provide one or more of fluid temperature set points, compressor settings of a heat pump system, and mixing valve settings information in order to achieve the user preferences and energy economic efficiencies, heating the fluid in response to the settings information to provide hot fluid according to the user preferences and to achieve the economic efficiencies, mixing of the hot fluid with a source of fluid so as to control an output fluid temperature of the hot fluid, and continually determining with the predictive controller the settings information, heating the fluid, and mixing of the hot fluid in response to the settings information so as to continually provide the hot fluid according to the user preferences and to achieve the economic efficiencies.

In one aspect, a method for heating fluid with a predictive controller configured to achieve user preferences and energy economic efficiencies is disclosed. The method comprises receiving input information including all of user preferences, energy price information, solar forecasting information, and GHG intensity information, determining future water demand information with a usage prediction model, determining with the predictive controller settings information to provide one or more of water temperature set points, compressor settings of a heat pump water heater, and mixing valve settings information in order to achieve the user preferences and energy economic efficiencies, heating the water in response to the settings information to provide hot water according to the user preferences and to achieve the economic efficiencies, providing the mixing valve settings information to a mixing valve to control an amount of mixing of the hot water with a source of water so as to control an output water temperature of the hot water; and continually determining with the predictive controller the settings information, heating the water, and mixing of the hot water in response to the settings information so as to continually provide the hot water according to the user preferences and to achieve the economic efficiencies.

One or more aspects and embodiments of the method include the predictive controller is a model predictive controller.

In one aspect, a heat pump system for heating fluid with a predictive controller configured to achieve user preferences and energy economic efficiencies is disclosed. The heat pump system includes any or all of a fluid storage tank, a fluid inlet, a fluid outlet, a heat pump sub assembly comprising a first heat exchanger in thermal communication with any of air, fluid and ground from and to which heat is being transferred, a second heat exchanger in thermal communication with the fluid storage tank, a compressor, a refrigerant heat transfer medium, one or more heating elements, a mixing valve and a database for storing input information. The heat pump system further comprises the database having an input for receiving input information including any or all of user preferences, energy price information, solar information, and GHG intensity information and for storing the input information in the database, a usage predictive model that receives the input information and determines future fluid demand information, a predictive controller that receives the future fluid demand information and the input information and that is configured to determine and provide settings information that includes one or both of fluid temperature set points and compressor settings so as to heat the fluid so as to achieve the user preferences and energy economic efficiencies, a mixing valve that mixes an amount of the hot fluid with a source of fluid so as to control an output fluid temperature of the hot fluid, and wherein the predictive controller is further configured to continually determine the settings information and heat the fluid in response to the settings information so as to continually provide the hot fluid according to the user preferences and to achieve the economic efficiencies.

In one aspect, a heat pump system for heating fluid with a predictive controller configured to achieve user preferences and energy economic efficiencies is disclosed. The heat pump system includes any or all of a water storage tank, a water inlet, a water outlet, a heat pump sub assembly comprising a first heat exchanger in thermal communication with any of air, water and ground from and to which heat is being transferred, a second heat exchanger in thermal communication with the water storage tank, a compressor, a refrigerant heat transfer medium, one or more heating elements, a mixing valve and a database for storing input information. The heat pump water heater system further comprising the database having an input for receiving input information including any or all of user preferences, energy price information, solar forecasting information, and GHG intensity information and for storing the input information in the database, a usage predictive model that receives the input information and determines future water demand information, a predictive controller that receives the future water demand information and the input information and that is configured to determine and provide settings information that includes one or both of water temperature set points and compressor settings so as to heat the water so as to achieve the user preferences and energy economic efficiencies, the mixing valve in response to setting information including mixing valve settings information controls an amount of mixing of the hot water with a source of water so as to control an output water temperature of the hot water; and wherein the predictive controller is further configured to continually determine the settings information and heat the water in response to the settings information so as to continually provide the hot water according to the user preferences and to achieve the economic efficiencies.

One or more aspects and embodiments of the heat pump system include the predictive controller is a model predictive controller.

In one aspect, one or more non-transitory computer-readable media storing instructions that, when executed by one or more processors, cause the one or more processors to perform operations to heat fluid with a predictive controller configured to achieve user preferences and energy economic efficiencies is disclosed. The operations comprise receiving input information including any or all of user preferences, energy price information, solar information, and GHG intensity information, determining future fluid demand information with a usage prediction model, determining settings information with a predictive controller to provide one or both of fluid temperature set points and compressor settings of the heat pump system in order to achieve the user preferences and energy economic efficiencies, heating the fluid in response to the settings information to provide hot fluid according to the user preferences and to achieve the economic efficiencies, mixing of the hot fluid with a source of fluid so as to control an output fluid temperature of the hot fluid, and continually determine the settings information with the predictive controller and instructions to heat the fluid in response to the settings information so as to continually provide the hot fluid according to the user preferences and to achieve the economic efficiencies.

In one aspect, one or more non-transitory computer-readable media storing instructions that, when executed by one or more processors, cause the one or more processors to perform operations to heat fluid with a predictive controller configured to achieve user preferences and energy economic efficiencies is disclosed. The operations comprise receiving input information including any or all of user preferences, energy price information, solar forecasting information, and GHG intensity information, determining future water demand information with a usage prediction model, determining settings information with a predictive controller to provide one or both of water temperature set points and compressor settings of the heat pump water heater in order to achieve the user preferences and energy economic efficiencies, heating the water in response to the settings information to provide hot water according to the user preferences and to achieve the economic efficiencies, providing mixing valve settings information to a mixing valve to control an amount of mixing of the hot water with a source of water so as to control an output water temperature of the hot water, and continually determine the settings information with the predictive controller and instructions to heat the water in response to the settings information so as to continually provide the hot water according to the user preferences and to achieve the economic efficiencies.

One or more aspects and embodiments of the computer-readable include instructions that cause the one or more processors to perform operations comprising providing the settings information with a model predictive controller.

In one aspect, a method for heating water with a predictive controller configured to achieve user preferences and energy economic efficiencies is disclosed. The method comprises receiving input information including any or all of user preferences, energy price information, solar forecasting information, and GHG intensity information, determining future water demand information with a usage prediction model, determining with a model predictive controller settings information to provide one or both of water temperature set points and variable compressor speed set points of a variable speed compressor of the heat pump water heater in order to achieve the user preferences and energy economic efficiencies, heating the water in response to the settings information to provide hot water according to the user preferences and to achieve the economic efficiencies, continually determining with the model predictive controller the settings information and heating the water in response to the settings information so as to continually provide the hot water according to the user preferences and to achieve the economic efficiencies.

In one aspect, a heat pump system for heating water with a predictive controller configured to achieve user preferences and energy economic efficiencies is disclosed. The heat pump system includes any or all of a water storage tank, a water inlet, a water outlet, a heat pump sub assembly comprising a first heat exchanger in thermal communication with any of air, water and ground from and to which heat is being transferred, a second heat exchanger in thermal communication with the water storage tank, a variable speed compressor, a refrigerant heat transfer medium, one or more heating elements, and a database for storing input information. The heat pump water heater system further comprises the database having an input for receiving input information including any or all of user preferences, energy price information, solar forecasting information, and GHG intensity information and for storing the input information in the database, a usage predictive model that receives the input information and determines future water demand information, a model predictive controller that receives the future water demand information and the input information and that is configured to determine and provide settings information that includes one or both of water temperature set points and variable compressor speed set points of the variable speed compressor so as to heat the water so as to achieve the user preferences and energy economic efficiencies, and wherein the model predictive controller is further configured to continually determine the settings information and heat the water in response to the settings information so as to continually provide the hot water according to the user preferences and to achieve the economic efficiencies.

In one aspect, one or more non-transitory computer-readable media storing instructions that, when executed by one or more processors, cause the one or more processors to perform operations to heat fluid with a predictive controller configured to achieve user preferences and energy economic efficiencies is disclosed. The operations include receiving input information including any or all of user preferences, energy price information, solar forecasting information, and GHG intensity information, determining future water demand information with a usage prediction model, determining settings information with a model predictive controller to provide one or both of water temperature set points and variable compressor speed set points of a variable speed compressor of the heat pump water heater in order to achieve the user preferences and energy economic efficiencies, heat the water in response to the settings information to provide hot water according to the user preferences and to achieve the economic efficiencies, continually determine the settings information with the model predictive controller and instructions to heat the water in response to the settings information so as to continually provide the hot water according to the user preferences and to achieve the economic efficiencies.

In one aspect, a method for heating fluid with a predictive controller is disclosed. The method comprises receiving status data from at least one of a plurality of apparatuses of a heat pump system transferring heat to or from a liquid, applying the status data to a usage prediction model to provide heated or cooled liquid usage prediction, applying the heated or cooled liquid usage prediction, compressor performance information, and present heat pump system information to a predictive control algorithm to determine one or more heat pump system instructions, and providing one or more heat pump system instructions to one or more apparatuses of the plurality of apparatuses in the heat pump system to modify operation of the heat pump system.

In one aspect, a method for heating fluid with a predictive controller is disclosed. The method comprises receiving heat pump status data from at least one of a plurality of apparatuses of a heat pump water heater system transferring heat to or from a liquid, applying the status data to a usage prediction model to provide anticipated hot water demand prediction, applying the anticipated hot water demand prediction along with at least one additional input signal from the heat pump water heater system to a heating controller configured to provide heat pump system instructions to operatively control when the system heats, to what target temperature the system heats, and by which heating method the system heats, transmitting one or more heat pump system instructions to one or more apparatuses of the plurality of apparatuses in the heat pump system to modify operation of the heat pump system including, operatively coupling the heat pump system instructions to a tempering device on the heat pump water heater such that the controller knows a tempering device is installed.

In one aspect, a heat pump system for heating fluid with a predictive controller is disclosed. The heat pump system includes any or all of a liquid storage tank, an inlet/supply line, a fluid delivery/outlet line, and an outer shell, a heat pump sub assembly comprising a heat exchanger in thermal communication with t air, water or ground from/to which heat is being transferred, a variable speed compressor, a fan, a condensate line, an expansion valve, a heat exchanger in thermal communication with the liquid storage tank, a refrigerant as a heat transfer medium within the heat pump system, The heat pump water heater further comprises at least one sensor measuring status data from at least one of a plurality of apparatus of a heat pump system, a database configured for storing status data gathered from the at least one sensor, a usage predictive model that receives the status data to provide heated or cooled liquid usage prediction, and a model predictive controller that receives the heated or cooled liquid usage prediction, compressor performance information, and present heat pump system information, and provides heat pump system instructions to modify operation of the heat pump system.

In one aspect, a heat pump system for heating fluid with a predictive controller is disclosed. The heat pump system includes any or all of a storage tank, an inlet/supply line, a hot water delivery/outlet line, a pressure relief valve, a condensate line, and an outer shell, a heat pump sub assembly comprising an evaporator, compressor, fan, expansion valve, a condenser, and refrigerant for transferring heat from the air into the water in the tank. The heat pump water heater further comprising at least one sensor measuring status data from at least of a plurality of apparatuses of a heat pump system, a database configured for storing status data gathered from the at least one sensor, a first predictive controller that receives the status data to provide heated or cooled liquid usage prediction, a second predictive controller that receives the heated or cooled liquid usage prediction, compressor performance information, and present heat pump system information, and provides heat pump system instructions to modify operation of the heat pump system.

In one aspect, a heat pump system for heating fluid with a predictive controller is disclosed. The heat pump system includes any or all of a storage tank, an inlet/supply line, a hot water delivery/outlet line, a pressure relief valve, a condensate line, insulation, and an outer shell, a heat pump sub assembly comprising an evaporator, compressor, fan, expansion valve, a condenser, and refrigerant for transferring heat from the air into the water in the tank. The heat pump system further comprises at least one sensor measuring at least one control signal in real time, a database capable of storing time series data gathered from the at least one sensor, a predictive controller that receives the at least control signal to provide anticipated hot water demand prediction, a controller that receives the anticipated hot water demand prediction along with at least one additional input signal from the heat pump water heater system and/or at least one signal external to the heat pump water heater system, and provides heat pump system instructions to operatively control when the system heats, to what temperature the system heats, and by which heating method the system heats, and a tempering device for tempering the temperature of the water delivered from the storage tank to the user.

In one aspect, one or more non-transitory computer-readable media storing instructions that, when executed by one or more processors, cause the one or more processors to perform operations to heat fluid with a predictive controller configured to achieve user preferences and energy economic efficiencies is disclosed. The operations comprising receiving status data from at least one of a plurality of apparatuses of a heat pump system transferring heat to or from a liquid, and applying the status data to a usage prediction model to provide heated or cooled liquid usage prediction, and applying the heated or cooled liquid usage prediction, compressor performance information, and present heat pump system information to a predictive control algorithm to determine one or more heat pump system instructions, and transmitting one or more heat pump system instructions to one or more apparatuses of the plurality of apparatuses in the heat pump system to modify operation of the heat pump system.

In one aspect, one or more non-transitory computer-readable media storing instructions that, when executed by one or more processors, cause the one or more processors to perform operations to heat fluid with a predictive controller configured to achieve user preferences and energy economic efficiencies is disclosed. The operations comprising receiving heat pump status data from at least one of a plurality of apparatuses of a heat pump water heater system transferring heat to or from a liquid, applying the status data to a usage prediction mathematical model to provide anticipated hot water demand prediction, applying the anticipated hot water demand prediction along with at least one additional input signal from the heat pump water heater system to a heating controller to provide heat pump system instructions to operatively control when the system heats, to what target temperature the system heats, and by which heating method the system heats, transmitting one or more heat pump system instructions to one or more apparatuses of the plurality of apparatuses in the heat pump system to modify operation of the heat pump system including, operatively coupling the heat pump system instructions to a tempering device on the heat pump water heater such that the controller knows a tempering device is installed.

### BRIEF DESCRIPTION OF THE DRAWINGS

Various aspects of at least one embodiment are discussed below with reference to the accompanying figures. The figures are included to provide illustration and a further understanding of the various aspects and embodiments, and are incorporated in and constitute a part of this specification, but are not intended as a definition of the limits of the aspects and embodiments of the disclosure. In the figures, each identical or nearly identical component that is illustrated in various figures is represented by a like reference numeral. For purposes of clarity, not every component may be labeled in every figure. In the figures:

FIG. 1—is a partially cut-away view of an exemplary embodiment of a heat pump water heater according to the disclosure;

FIG. 2 illustrates an exemplary embodiment of a tempering device integrated with a heat pump water heater according to the disclosure;

FIG. 3 illustrates one embodiment of a predictive controller for a heat pump hot water heater system according to the disclosure;

FIG. 4 illustrates an embodiment of a predictive controller using a receding horizon model predictive control for a heat pump hot water heater system according to the disclosure;

FIG. 5. illustrates an example of performance of a heat pump hot water heater system with predictive control illustrating some benefits of the predictive controller;

FIG. 6 illustrates an embodiment of a reinforcement learning predictive controller for a heat pump hot water heater system according to the disclosure;

FIG. 7 illustrates an embodiment of a rules based predictive controller for a heat pump hot water heater system according to the disclosure;

FIG. 8 is a block diagram of an example of a computer system for implementing aspects and embodiments of the methods and system disclosed herein; and

FIG. 9 is a block diagram of an example of a system architecture according to aspects and embodiments of this disclosure.

### DETAILED DESCRIPTION

The phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the aspects and embodiments, it will be understood that a number of elements, techniques and steps are disclosed. Each of these has individual benefits and each can also be used in conjunction with one or more, in some cases all, of the other disclosed elements, techniques, and steps. Accordingly, for the sake of clarity, this description shall refrain from repeating every possible combination of the individual steps, elements and techniques of the disclosure in an unnecessary fashion. Nevertheless, the specification and claims should be read with the understanding that any and all such combinations are entirely within the scope of the disclosure and the claims.

An aspect of the present disclosure is a method and system for controlling heat transfer to a fluid, where the method and system includes a heat pump system with a variable speed compressor, a tempering valve (also known as a mixing valve), and a predictive controller. Aspects and embodiments of the method and system include measuring fluid usage, storing information regarding fluid usage, predicting future fluid usage, incorporating external information inputs including but not limited to price information, localized solar production information, GHG intensity information, user preferences, and controlling the heat pump system. The uses of the fluid comprise domestic hot water, heating, cooling, and energy storage for heating and cooling. It will be evident to those of skill in the art that heat pump systems can be operated to effect cooling as well as heating. In the disclosure the use of the terms Heat Pump Hot Water Heater (HPHW) heater, Heat Pump Hot Water (HPHW) heater system, Heat Pump Hot Water (HPHW) heater service, Heat Pump System, and heat pump water heater (HPWH) are intended to include all of these heating and cooling uses and are to not be limited to domestic hot water systems. The terms Heat Pump Hot Water (HPHW) heater, Heat Pump Hot Water (HPHW) heater system, Heat Pump Hot Water (HPHW) heater service, Heat Pump System, and heat pump water heater (HPWH) are used interchangeably throughout the disclosure. In the following description, for purposes of explanation, numerous specific examples are set forth in order to provide a thorough understanding of the present disclosure. It will be evident to one skilled in the art that the present disclosure may be practiced without these specific details. It is understood that the disclosed mode of operation does not preclude other methods of controlling a heat pump system, whether cited in the prior art or not, from also being enabled, activated, and deactivated on heat pump systems.

The present disclosure is intended to be an exemplification of various methods and systems of controlling a heat pump system including determining the temperature setpoint(s) and the compressor setting(s) of the heat pump system based on various input information that can be considered or not by a controller based on user preferences, so as to achieve user preferences and economic efficiencies, but is not intended to limited to the specific combinations of elements and embodiments illustrated by the figures or descriptions below. It is appreciated that all disclosed steps of all embodiments of all disclosed methods and all elements of all disclosed embodiments of all disclosed systems can be combined in any manner.

Aspect and embodiments of the present disclosure comprises a heat pump system, and can be include, for example, in an internet-enabled software application residing on the heat pump and which is also communicatively coupled to a cloud-based software infrastructure (i.e., “The Internet of Things” or IoT) via Wi-Fi, cellular, ethernet or other communications methodology. The heat pump system referred to herein is understood to be a heat pump system that can be purchased and installed within or immediately adjacent to a building, connected to the internet at least via the system and methods disclosed herein, and to include a tank for storing a liquid. If the heat pump system is heating domestic hot water, the tank is understood to be plumbed to a water supply and a hot water distribution system which provides water to various outlets within the building such as shower heads, sinks, and baths. If the heat pump system is heating or cooling the building, then the tank is understood to be thermally connected to the heating and cooling distribution system of the building. For example, the tank may be connected to air ducts via an air to water heat exchanger. Alternatively, the tank may be connected to baseboards in a hydronic heating system. According to aspects and embodiments, one or more users are able to communicate with the heat pump system via any or all of, for example, a control screen on the heat pump, tank or a software application downloaded to their phone, tablet, computer or other similar device. Those with ordinary skill in the art to which this disclosure belongs will understand that other components which provide the same respective functions as control panels, internet connections, plumbing, internet-enabled software applications, etc. may also be used with the methods and systems of the present disclosure.

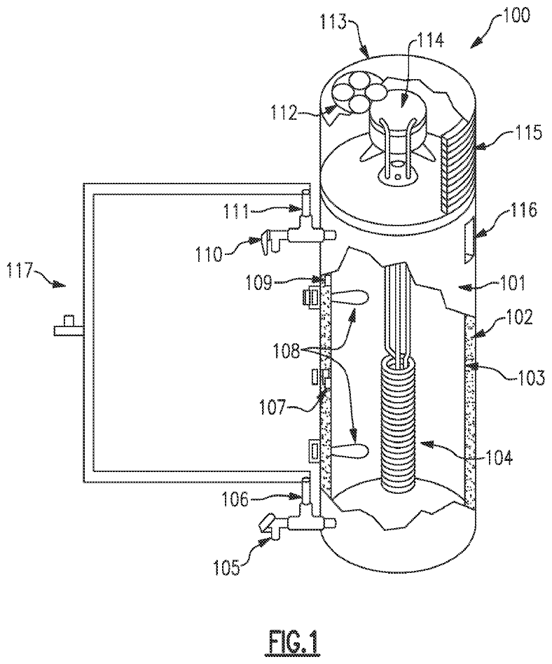

FIG. 1 provides a partially cut-away perspective view of an exemplary embodiment of a heat pump water heater 100, which comprises one possible embodiment and application of the current disclosure. Heat pump water heater includes a tank casing 101 that encloses insulation 102 between tank casing 101 and tank 103. The condenser 104 of the heat pump system is located inside the tank in this exemplary embodiment though in other exemplary embodiments the condenser may be wrapped around the tank 103. A drain 105 and a cold-water inlet 106 are included in the heat pump water heater and are located at the bottom of the tank 103. A lower thermostat 107 is located inside the insulation 102 on the surface of the tank 103 and measures temperature in the lower region of the tank 103. Two electric resistance elements 108 deliver heat to the tank 103. The upper thermostat 109 is located inside the insulation 102 on the surface of the tank 103 and measures temperature in the upper region of the tank 103. A temperature/pressure relief valve is provided 110, as is a hot water outlet 111. A fan 112 creates air flow so that heat can be drawn from the air. The heat pump casing 113 encloses the upper portion of the heat pump water heater 100. The compressor 114 is housed within the heat pump casing 113, as is the evaporator 115. An expansion valve (not shown), refrigerant lines (not shown) and temperature or pressure sensors (not shown) are provided in the heat pump casing 113 as additional components of the heat pump system. A master controller 116 includes memory, one or more processing devices, and communications components such as an internet wireless radio (Wi-Fi), Bluetooth transmitter, or comparable communications device and may also contain a touch-screen for user interaction. The master controller 116 may contain information comprising user preferences comprising the water setpoint temperature (or “nominal setpoint temperature”). A tempering device 117 operatively couples the cold water inlet 106 with the hot water outlet 111 such that hot water from the tank is mixed with colder water from the inlet to deliver water to the user at a temperature between the hot and cold temperatures. The tempering device 117 may be a thermostatic mixing valve, an electronic mixing valve, or another comparable device familiar to one ordinarily skilled in the arts.

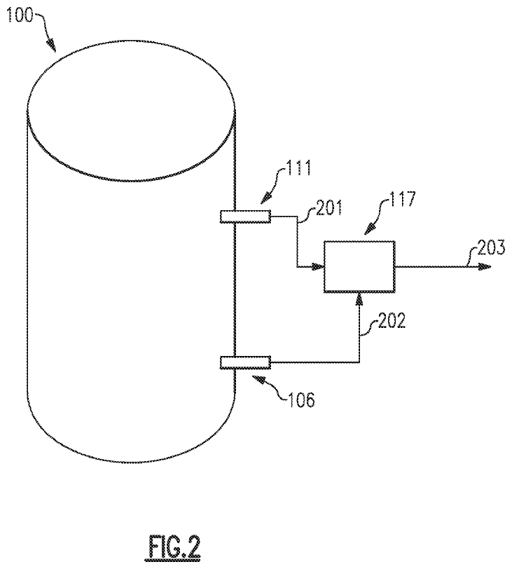

FIG. 2 operatively illustrates one embodiment of a tempering device 117 (aka mixing valve) that may be integrated into the heat pump water heater 100 (or installed in operative connection with the heat pump water heater) that comprises one possible application of aspects and embodiments of the current disclosure. The tempering device 117 enables warm water 201 from the outlet 111 of the heat pump water heater 100 to mix with cooler water 202 from the inlet 105 (note that the inlet pipe to the water heater inlet is not shown), such that the delivered water 203 to the user is at temperature between the water 201 and 202. Thus, the tempering device 117 enables a decoupling of the temperature of the water stored in the heat pump water heater 100 from the temperature of the delivered water 203 to the user. For example, the tempering device 117 may enable the water stored in the tank to be heated to e.g., 140° F. while still delivering water to the user at a more typical and safer temperature of e.g., 120° F. The tempering device 117 may comprise a thermostatic mixing valve, an electronic mixing valve, or another tempering device familiar to one ordinarily skilled in the art. The tempering device 117 may also include a means by which to adjust the temperature of the delivered water 203, either mechanically (for instance, with a knob or dial) or with electronic controls. The tempering device may be contained external to the heat pump water heater 100 or it may be contained internally as in within a casing or otherwise.

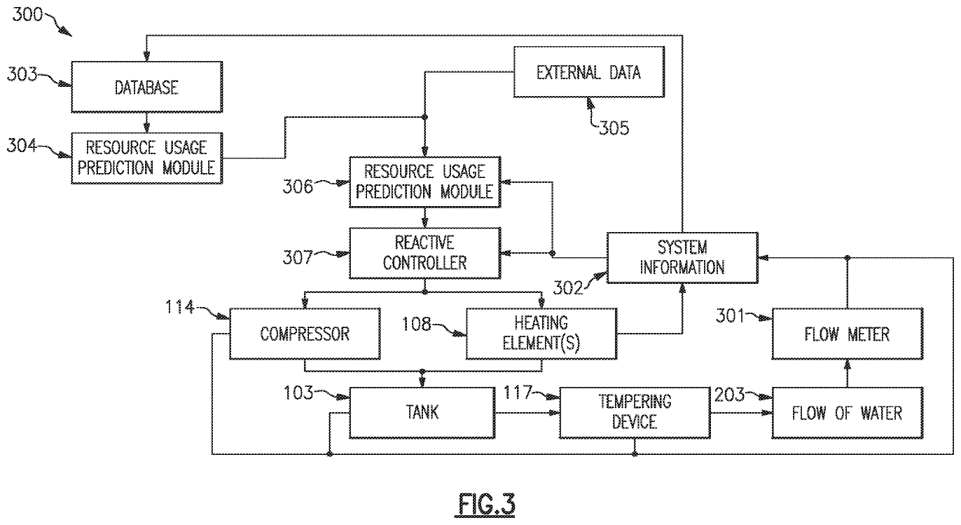

FIG. 3 operatively illustrates an embodiment of a predictive controller for a heat pump hot water heater system according to aspects and embodiments of the disclosure. A flow meter 301 measures hot water usage per unit time. The flow measurements and the corresponding time of their occurrence may then be stored in a database 303, this database 303 being located either on the heat pump system 100 (not shown), in a suitable cloud-based storage system, or in another appropriate data storage system that will be evident to one skilled in the art of the present disclosure. The database may also receive a signal from the heat pump water system 100 (not shown) comprising system information 302. The system information 302 may comprise a measurement of a system variable, for example including but not limited to temperature measurements of the water in the tank, temperature of the water flowing into the tank, the refrigerant temperature and/or pressure at various locations in the refrigerant loop, temperature of the air flowing into the heat pump water heater, energy use rate, expansion valve position measurements, a compressor speed measurement, mixing valve setting, or a combination thereof. These measurements may be instantaneous or aggregated over time (summed, averaged) or otherwise collected in a relevant format that will be evident to one skilled in the art of the present disclosure. The system information 302 and the corresponding time of their occurrence may then be stored in a database 303.

According to one embodiment, a future (anticipated) resource usage prediction module 304 utilizes the data from the database 303 and other information to generate a continually updated model for future resource usage that provides future resource usage prediction information. Resource usage information may be summed or averaged by segments of duration (e.g. bins), such as 15, 30 or 60 minutes, and time of occurrence information may include day of the week, weekday versus weekend, holiday versus non-holiday, month, season, and more. Other information that may be input into the future resource usage prediction module 304 may comprise weather information, occupancy information, information from other building devices (thermostats, refrigerators, HVAC equipment, lights, smart building management systems, etc.), user preferences, information from other buildings with similar usage profiles, and more. Numerous methodologies may be used to perform the future resource usage prediction, including but not limited to a rolling average (e.g., a 14 day window for weekdays and 10 weekends for weekend days) where the resource usage is averaged for bins throughout the day (e.g. 30 minute bins), and those bins are separated to distinguish between weekday and weekend usage patterns. For example, that methodology was used for simulation and field prototyping. Those skilled in the art to which this disclosure belongs will recognize that numerous methodologies exist for time series forecasting, including but not limited to autoregressive models, autoregressive integrated moving average models, seasonal autoregressive integrated moving average, exponential smoothing, Prophet, Long Short-Term Memory (LSTM), DeepAR, N-Beats, Temporal Fusion Transformer, Multi-Layer Perceptron, Bayesian Neural Network, Radial Basis Functions Neural Network, General Regression Neural Network, K-Nearest Neighbor Regression Neural Network, CART Regression Trees, Support Vector Regression, and Gaussian Processes, and more. Such strategies are appreciated by and intended to be within the scope of this disclosure. According to aspects and embodiments, the future resource usage prediction information is provided to the predictive controller 306.

According to aspects and embodiments, external data 305 comprising local solar forecast information, real-time solar information (including but not limited to irradiance and inverter output), home battery information, home electrical panel information, smart home automation information, weather forecast information, electricity price information or schedules, carbon intensity of the grid (instantaneous or forecasted), demand response information, user preference information, is also provided to the predictive controller 306. The predictive controller may also receive system information 302 from the heat pump water system 100.

According to aspects and embodiments, the predictive controller 306 utilizes any or all of this information to output preferred settings for the reactive controller 307. These preferred settings may comprise an instantaneous setpoint temperature for the water, an instantaneous compressor speed setpoint, a schedule of temperature setpoints over time, or a schedule of compressor speed setpoints over time. These preferred settings may vary hour to hour, day to day, home to home, and region to region depending on the circumstances of the time varying conditions of the variable inputs (weather, insolation, resource usage) as well as the semi-permanent or permanent conditions (home location, other home systems, installation location of the heat pump system, electricity rate, occupant preferences, etc.). Numerous strategies may be utilized for the predictive control described above, as shall be described in further detail in this disclosure.

According to aspects and embodiments, the predictive controller 306 provides preferred settings to the reactive controller 307, which also receives system information 302. The reactive controller 307 uses setpoint, proportional-integral-derivative (PID) control, or other control methods to turn on and off the compressor and/or heating elements to heat water in the tank according to the setpoints established by the predictive controller 306. The reactive controller 307 may include deadbands, proportional weighting between upper and lower temperature sensor measurements, and other features that those skilled in the art of the present disclosure will understand are common to water heating systems. The predictive controller may provide any of the reactive controller's settings, including but not limited to temperature setpoint, compressor speed setpoint, fractional weighting between temperature sensors, deadband offsets, and more. These settings may be provided in formats comprising single point values or time based schedules.

According to aspects and embodiments, the reactive controller 307 sends signals to the compressor 114 and the heating elements 108, which heat water in the tank 103. According to aspects and embodiments, the tempering device 117 ensures a consistent water temperature of the water flowing 203 out of the heat pump water heater.

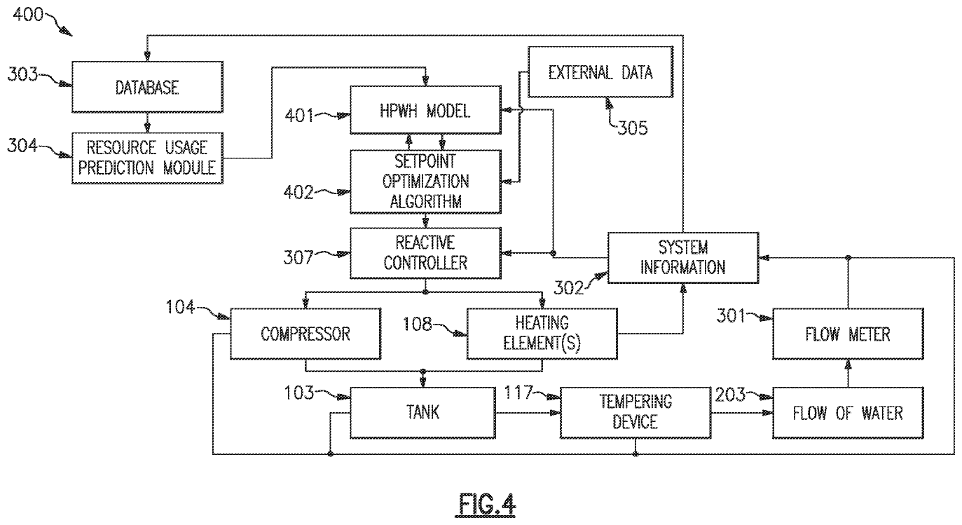

FIG. 4 illustrates one embodiment of a predictive controller using a receding horizon model predictive control (MPC) algorithm for the predictive controller 306. In this embodiment, the predictive controller 306 is replaced by a time-varying physics-based HPWH model 401 and a setpoint optimization algorithm 402. The HPWH model 401 consists of a nodal tank model, a compressor map, and ancillary elements. The nodal tank model (not shown) decomposes the hot water tank into stacked discs and uses established heat transfer relationships to model the addition of heat from the compressor and/or heating element to the water, the heat transfer between the nodes, the flow of water into and out of the tank, and the heat loss from the tank through its exterior. For example, in simulation, lab prototypes, and field prototypes, a 15 node tank model was effectively utilized in the MPC algorithm. The compressor map is a table, generally provided by the compressor manufacturer or developed through testing, that outputs the thermal capacity of the compressor for a given set of conditions; those conditions being the ambient temperature and humidity of air at the evaporator (for an air source heat pump water heater), the compressor partial load percentage (for a variable speed compressor), and the water temperature in the tank that is operatively connected to the refrigerant in the condenser of the heat pump system. Ancillary elements comprise relevant information on the size and location of the heating element(s), location of the temperature sensors, setpoint of the tempering device, and other related pieces of system information. The setpoint optimization algorithm 402 in MPC works by testing different compressor and temperature setpoint scenarios across a specific time horizon using the HPWH model 401, the output of the resource usage prediction module 304, and the external data 305. The results of each setpoint scenario are calculated in the objective function and the best performing scenario is implemented by transferring these compressor speed and water temperature settings to the reactive controller 307. This approach is distinct from U.S. Pat. No. 10,378,805 B2, in which the MPC algorithm only tests different water temperature setpoints. That approach is insufficient for the control of a variable speed compressor, as the compressor speed and not just the target water temperature setpoint must be altered by the control algorithm to maximize results. These settings are maintained for a defined period of time (‘control horizon’) and then the algorithm is executed again. For example, in simulation, MPC was implemented using a structure of three windows of two hours each (a six hour prediction horizon) for the compressor speed and water temperature settings, a one minute time step in the HPWH time-varying physics model, and a two hour control horizon (e.g. the output settings were implemented for two hours, and then new optimal settings were identified). Heat pump temperature setpoint was restricted to two options (140° F. and 120° F.), and three compressor settings were available (2,000 RPM, 3,000 RPM, 4,000 RPM). The upper heating element was restricted to a single setpoint for activation (120° F.), and the lower heating element was not activated. With these parameters and using a comprehensive search strategy, 216 scenarios were tested per prediction horizon calculation (i.e. every two hours, 216 scenarios were explored for the upcoming six hour horizon): (3 compressor settings×2 heat pump temperature setpoints×1 upper element temperature setpoint)\hat{ }(3 windows). Computing 216 scenarios per prediction horizon is well within the computational load of inexpensive modern computing hardware. For field prototypes, the compressor was restricted to only two speeds, resulting in 64 scenarios per prediction horizon. Those skilled in the art of the present disclosure will recognize that as the parameter space increases, other optimization strategies (various types of gradient descent, to name just one) besides comprehensive search (aka brute force) may be utilized, and such strategics are appreciated by and intended to be within the scope of this disclosure.

In a preferred embodiment of the disclosure, the objective function is configurable. This may be done by the occupant, the installer, or some other appropriate party (i.e. landlord) at installation or updated at a later time. The utility of this configurability is that while all occupants may reasonably be expected to prefer comfortable hot water and thus no sag (sag being defined as hot water delivered at less than roughly (110° F.), only some homes or homeowners will be subject to time varying electricity rates (aka time of use (TOU) rates), have a solar (or wind) and/or battery system with differential pricing for providing electricity to the grid, have an intrinsic desire to synchronize water heating with their solar (or wind) system regardless of economic incentives, have a smart home controller that can perform holistic optimization, or have an intrinsic desire or economic incentive to minimize GHG emissions by synchronizing water heating with periods of low GHG intensity electricity. The objective function thus comprises terms for comfort, energy efficiency, cost, GHG emissions, and local solar content.

For example, in simulation and field prototypes, scenarios were scored on sag minimization, energy efficiency (minimization of energy use per unit of heat delivered), cost minimization, GHG emissions minimization, and local solar content (minimization of external energy). Scenarios were then compared criteria by criteria, with the order of the comparison being configured according to the installation circumstances and user preferences. In addition, some criteria are inherently removed in some scenarios by the application of external information. For example, the cost criteria is redundant with energy efficiency criteria if all of the prices are the same, Similarly, if a constant GHG emissions value is applied, then GHG minimization is redundant with the energy efficiency criteria. Those skilled in the art to which this disclosure belongs will recognize that other methods for multiple criteria optimization may be applied to this step of the method, including weighting the criteria, normalizing criteria values against a benchmark value, normalizing the value of the criteria between scenarios before weighting, and that such methodologies are appreciated by and intended to be within the scope of this disclosure.

An introduction to the performance of variable speed compressors 114 and tempering devices in water heating will illustrate advantages and the utility of aspects and embodiments of this disclosure. When a variable speed compressor 114 is operated at a lower speed the water heating, heat transfer through the heat pump system is reduced—heating occurs more slowly. However, the lower rate of heat transfer results in lower approach temperatures at the heat exchangers (evaporator 115, condenser 104); this characteristic increases heat transfer efficiency. In sum, the absolute heat transfer rate goes down, but heat transfer efficiency (coefficient of performance) goes up. This effect can be substantial: heating times may be doubled with energy savings up to 25-30%. The tempering device (aka mixing valve) mixes cold water with hot water from the tank at the tank outlet if the hot water from the tank is above the tempering device temperature. In the context of this disclosure, this has two important benefits. First, the tempering device enables the system to deliver up to 60% more hot water without reheating, with the percentage of increase dependent upon the temperature of the cold water being mixed in. Second, the tempering device maintains a consistent outlet water temperature, which is important for user comfort, user experience and safety. Comfort in this context means a comfortable hot water temperature, generally considered to be above 110° F. User experience arises from consistency—the shower dial or faucet handle can be placed in the same position and the same water temperature will be delivered. Safety is paramount: at a water temperature of 140° F., a second degree burn occurs in three seconds and a third degree burn occurs in five seconds.

Some examples of the utility of the disclosure are now illustrated. The resource usage prediction module 203 enables the system to automatically and dynamically anticipate the hot water usage needs of the home in order to create a heating strategy optimized for that home. This contrasts with today's systems which heat reactively—that is, based on measurements of the present temperature of the water in the tank. This approach is flawed in that it has no insight into how a home typically uses hot water, and can thus lead to scenarios where a home's water heater is underprepared and/or water is not heated at optimal efficiency. Although some systems are capable of programming fixed usage schedules in order to better adapt how the system heats, this programming requires manual intervention on the part of the user and is rarely done. Furthermore, this schedule is fixed over time unless the user updates the schedule.

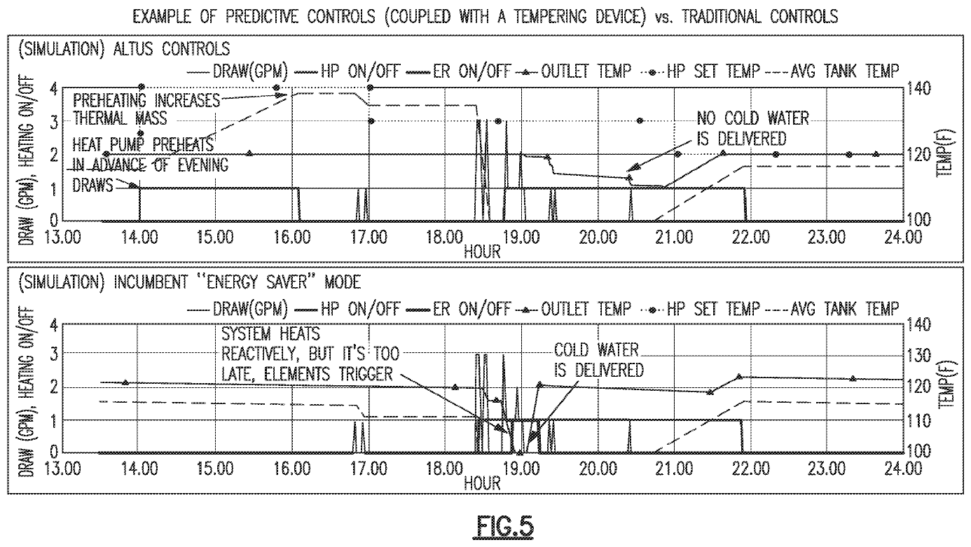

FIG. 5. illustrates an example of performance of a heat pump hot water heater system with predictive control illustrating some benefits of the predictive control in comparison with a heat pump hot water heater system without predictive control. Consider a scenario where a home's heat pump water heater (in this example, a unit with a nominal 50 gallon capacity) has been previously heated sometime in the morning and is thus in a “fully charged” state as the afternoon begins (i.e.—the average tank temperature is around the nominal setpoint of 120° F.). Little to no usage occurs throughout the afternoon, but between 6-8 PM there are a series of larger draws totaling roughly 40 gallons of usage. A typical heat pump water heater control strategy will take no heating action during the afternoon—because there was not enough hot water usage to trigger heating—and thus when the large draws begin in the evening two shortcomings of the system will emerge. The first shortcoming is that some water will be delivered to the customer below the comfort threshold (often considered to be 110° F. or under); the second is that the system will reactively trigger the resistance element(s) resulting in a relatively quick, but highly energy inefficient recovery.

Now consider an example with the same initial conditions, except where the heat pump water heater is an embodiment of the disclosure. Because the system anticipates the period of little to no usage in the morning, water is heated slowly throughout the day at high efficiency. In addition, the setpoint is increased further (e.g., from 120° F. to 140° F.) early in the afternoon, allowing sufficient time for additional thermal mass to be added to the tank slowly and at high efficiency. When the larger draws come in the evening, sufficient thermal mass is available to both (i) deliver water without sacrificing comfort, quality of user experience and safety and (ii) avoid the use of the resistance element(s) to reheat water. After the period of high demand, the predictive controller sets the setpoint temperature to 120° F. and the compressor setpoint to low, allowing for high efficient reheating overnight. In both a simulated and lab environment where such a scenario was tested, the method and system reduced energy consumption by more than 20% while also delivering better hot water performance measured as both the average temperature of water delivered, and the consistency of temperature delivered.

Additional examples of the utility of the method and system of this disclosure are as follows. The predictive controller 306 includes the ability to utilize external inputs 305 in order to operatively adapt heating to better meet a home's usage needs. This adaptation may include shifting the heating in time and/or elevating the setpoint above the nominal setpoint in order to increase the amount of thermal mass stored in the tank 103—this functionality is made possible by the coupling of the predictive controller 306 to the tempering device 117. Among the external inputs which may be utilized are: solar data (instantaneous and/or forecasted, weather data (instantaneous and/or forecasted, electricity price data (instantaneous and/or forecasted, demand response signals, GHG intensity data (instantaneous and/or forecasted), and more. In a first example, the predictive controller 206 receives a signal 305 indicating that solar production at a given home will be high on a particular afternoon, for example from 2:00 to 5:00 PM. The controller 206 also knows, via the resource usage prediction module 304, that this particular home will primarily use hot water later in the evening, say after 7:00 PM on this particular day (e.g., a weekday). Assume also that this home uses hot water in the morning between 7:00 AM from 9:00 AM. In a typical system, the morning hot water usage is likely to trigger reactive heating, either with the heat pump and/or with the inefficient resistance element(s) 108. In contrast, because the predictive controller 206 is aware via the resource usage prediction module 304 that there will be no demand following the morning usage, and via the external inputs 305 that there will be high solar production later in the afternoon, the controller 306 prevents any heating from occurring until the afternoon. Additionally, because the controller 306 is operatively coupled to the tempering device 117, the predictive controller 306 may elect to elevate the setpoint during the period of high solar production in order to increase the amount of thermal mass stored in the tank 103, 310, thus enabling the system to meet the evening demand with more of the hot water produced from the home's solar system. In a comparable example where the external data 305 of interest is instead electricity price forecasting, the predictive controller 306 may elect to concentrate heating to a time when electricity prices are lower while still accounting for the anticipated future demand via the prediction module 304 so as to more cost effectively meet the home's real hot water needs. Importantly, the predictive controller 306 may also choose to elevate the setpoint during the low-price hours in order to increase the amount of thermal mass stored in the tank 103, again made possible via the operative coupling of the heat pump water heater system 100 to the tempering device 117. This contrasts with today's systems which do not take into account electricity pricing and/or where electricity pricing must be continuously and manually programmed in by the user, which is not preferential.

Another example of the utility of the methods and systems of this disclosure is as follows. Water heaters may be used as a grid asset via participation in demand response programs. These programs will send signals to the water heater to either “load up” or “shed load” depending on the electrical usage on the grid. While today's water heaters are capable of “loading up” or “shedding load” based on these signals, they do so “blindly” without insight into whether this is beneficial or detrimental to the occupants of the home based on their hot water usage. For example, a water heater participating in demand response may receive a signal to “load up”. However, if the occupants of the house do not typically use water during or after the “load up” period, there is little to no benefit to executing this command. However, with a predictive controller 306 operatively coupled to the tempering device 117, the system can determine if such a load up command will be beneficial based on the resource usage prediction module 304, or alternatively can modify the amount of “load up” to better meet the home's actual needs. Thus, water heating systems and methods of this disclosure are able to increase heating efficiency and/or shift water heating to meet the future load while also factoring in external data 305. Preferably, the system can determine when it is preferential to not do so as well. In contrast, even in cases where a tempering device may have been installed or retrofitted on one of today's water heating systems, these systems nonetheless lack the ability to proactively determine when and by how much to elevate the setpoint, which is likely to result in sustained periods of unnecessary overheating and/or heating with the far less efficient resistive elements 108. Further, no currently available heat pump water heaters use variable speed compressors and a predictive controller to enable slower, higher efficiency heating at appropriate times for each installation.

Quantitative data will illustrate the utility of the present disclosure and expand upon the aforementioned examples. A field prototype unit operating one embodiment of the disclosure provided up to a 17% reduction in normalized energy use (energy use per gallon of hot water delivered, or kWh/gal) versus the existing heat pump water heater ('baseline heat pump water heater') installed at the site. The baseline heat pump water heater utilized a fixed speed compressor, no mixing valve, and reactive controls. For this home, this reduction corresponded to a lifetime savings of approximately $250.00. Comfort was unaffected. In simulations using environmental conditions, home installation placements (garage, basement, attic, etc.), and energy prices from several locations throughout the U.S. and varied real-world draw patterns, a heat pump water heater with the embodiment of the disclosure reduced sag by up to 100% and reduced energy consumption by up to 23% under flat energy prices, corresponding to a maximum lifetime savings of up to $580 (energy price inflation not included). In all scenarios, energy use was reduced and comfort was improved, even though these parameters are in tension with one another. In similar simulations using Time of Use pricing schedules from California, cost was reduced by up to 47% sag by up to 67%, with averages of 31% and 46%, respectively. In simulations using real-world irradiance information, home installation placements (garage, basement, attic, etc.), and hot water draw patterns, a HPWH with the embodiment of the disclosure increased the percentage of hot water generated via the home solar system from 44% to 60% in Hartford, CT and from 78% to 84% in Houston, TX while also reducing sag by 20% and 17%, respectively. In simulations using real-world GHG forecasts, home installation placements (garage, basement, attic, etc.), and hot water draw patterns, a HPWH with the embodiment of the disclosure reduced GHG emissions by up to 14% while also reducing sag by half, a result that can be expected to increase as the variability of carbon intensity increases in years to come.

An embodiment of the disclosure related to occupant comfort is now described. Heat pump water heaters expel cooled and dehumidified air which has passed through the evaporator. This cooling and dehumidifying effect may be detrimental to occupant comfort depending on the location within the building envelope where the water heater is installed. For example, if the water heater is installed within a space which is occupied some or all of the time, the occupants of that space may view the cooling as unwanted. Alternatively, there may be times during the year where the cooling is actually welcomed (e.g., during the warmer months) whereas during other times of the year it may be unwelcomed (e.g. during the cooler months). Thus, it would be advantageous for a water heating system to be (i) capable of shifting heating to times when the space is unoccupied (thus giving the space time to come back up to temperature before it's occupied again); (ii) knowing when the occupants prefer cooling vs. when they may not; and (iii) to be able to store additional thermal mass in the tank to minimize the number of water heating events that would impact cooling of the surrounding environment. The current methods and system for operating a heat pump water heater suffer from limitations in terms of their ability to shift heating in order to avoid the cooling and dehumidifying when it's unwanted, as well as their ability to store additional thermal capacity. Aspects and embodiments of the present disclosure, however, can shift when it heats in time and/or how rapidly it heats during a given period. To enable this capability, information and user preferences comprising one or more of the following may be gathered: heat pump water heater location within the home, user comfort preferences including times during which a cooling and dehumidifying effect may be allowed (note here that “times” may refer to any portion of time including hours during the day, days during the week, seasons during the year, or otherwise) as well as a ranking or weighting of how much a user may be willing to sacrifice comfort in lieu of energy efficiency or vice versa. The controller 200 utilizes these inputs, along with its ability to anticipate future demand, in order to develop a heating strategy that best meets the hot water needs of the home while minimizing any discomfort due to the cooling and dehumidification benefit.

As an example of the utility of this disclosure, consider a heat pump water heater installed in the basement of a home in New England in the winter. During the day this space is used as an office by one of the occupants of the home, so a cooling effect is not desired during those hours. With a typical heat pump water heater system, water heating may occur during the day while the user is in said space, resulting in undesired and uncomfortable cooling. However, with a system that operatively couples a tempering device 117 to a predictive controller 306, water heating could be intelligently shifted to happen many hours prior to when the space will be occupied, thus giving this space time to come back up to temperature after heating has concluded. For instance, imagine that the predictive controller knows that no hot water usage is expected until 8:00 AM. The system may actively raise the temperature setpoint of the unit to e.g., 140° F. at 9:00 PM the night before. Using a low speed on the compressor, heating will have concluded efficiently overnight and the heat pump system will turn off, thus stopping any cool exhaust air from flowing into the space. By the time the morning usage begins several hours later, not only does the tank have more thermal mass in order to better meet demand, but the space has been given the time to come back up to temperature so that it is comfortable for the occupant utilizing it as an office. In some embodiments, such behavior may be programmable as a distinct mode within the unit e.g., “Comfort Mode”. In other embodiments, this behavior may be automatically triggered as a result of typical usage patterns as well as information programmed in by the user during setup—e.g., a user may indicate that the water heater is located in a space typically occupied during the hours of 8:00 AM-1:00 PM. The system would leverage this information to not only meet anticipated usage, but to do so in a way that minimizes or eliminates any discomfort in the space around the water heater due to the cooling that occurs with the heat pump.

It is appreciated that the variable speed compressor 114 and tempering device 117 each contribute significantly to the overall utility of the disclosure and that this utility is reduced but not eliminated if one or the other of these elements is removed. Specifically, if a fixed rather than variable speed compressor 114 is utilized in the water heating method and system embodying this disclosure, as is common in heat pump water heaters today, then the method and system retain the capability to shift water heating in time to deliver numerous benefits, including but not limited to improving hot water comfort by reducing instances of sag, increasing system efficiency and reducing cost by decreasing use of the resistive heating elements, decreasing cost by shifting water heating away from periods of high energy price and/or low local solar production (for homes without net metering), reducing greenhouse gas emissions by shifting water heating to periods of low GHG intensity in the local electricity, and shifting water heating to periods of low occupancy in the space affected by the cooling from the system. The ability to increase or decrease the compressor speed at times identified by the predictive controller in order to save money, increase heating energy efficiency, reduce GHG emissions, and increase utilization of local distributed energy, however, is lost. Alternatively, if a variable speed compressor 114 is used in a water heating system embodying this disclosure but a tempering device 117 is excluded, then the system retains the ability to save money, reduce emissions, and reduce costs, and increase the utilization of local solar/wind production by altering compressor speed and settings such as the fractional weighting between thermostat sensors on the tank. The extent to which heating can be shifted in time, however, is reduced by the inability to significantly elevate the overall setpoint temperature of the tank—thus materially increasing the thermal mass in the tank—due to comfort, user experience, and safety concerns. The implementation of this disclosure without either the variable speed compressor 114 or the tempering device 117 is also appreciated by and intended to be within the scope of this disclosure.

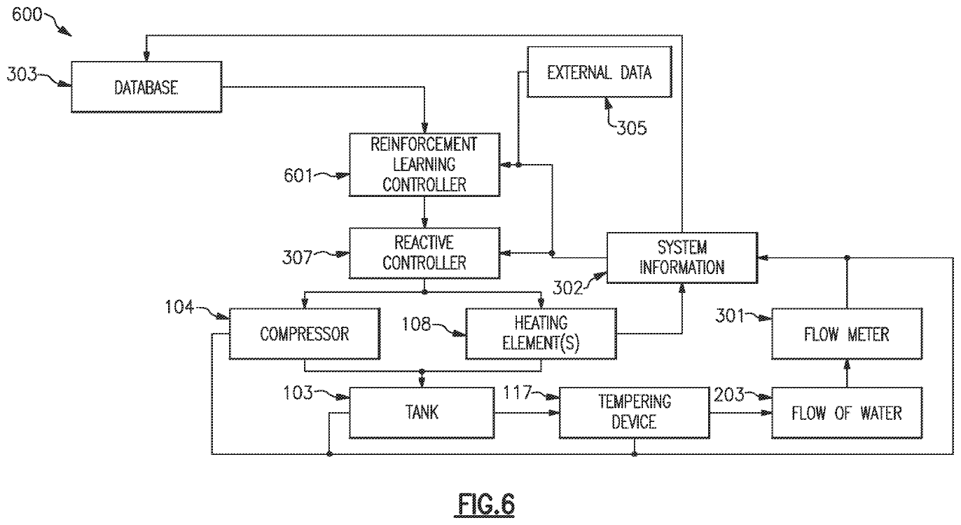

It is appreciated that the predictive controller described in this disclosure may utilize strategies other than receding horizon model predictive control. FIG. 6, for example, illustrates an embodiment of a reinforcement learning predictive controller according to the disclosure. FIG. 6, depicts a reinforcement learning (RL) controller 601 that utilizes a reinforcement learning algorithm to replace the resource usage prediction module 304 and the predictive controller 306, or just the predictive controller 306 (the former approach is shown in FIG. 6). Such a RL algorithm would output settings to the reactive controller comprising compressor speed and water setpoint temperature (instantaneous or a schedule over time) based upon inputs comprising system information 302, and external data 305 comprising weather information, occupancy information, information from other building devices (thermostats, refrigerators, HVAC equipment, lights, smart building management systems, etc.), user preferences, price information, solar/wind information, local GHG emissions, and more. The RL algorithm in the RL controller 601 would be trained through massive repetition on diverse scenarios to output optimal control signals for a given set of input signals.

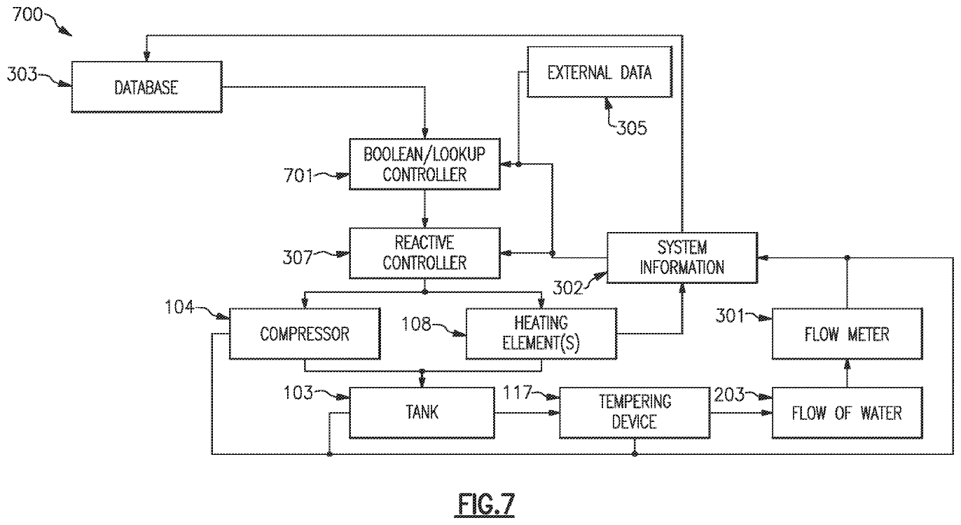

Alternatively, predictive control for the temperature setpoint may be implemented by a rules-based (aka IF . . . THEN or boolean logic) approach, for example as depicted in FIG. 7. In this approach, the output of the resource usage prediction module 304 is used to determine if the amount of hot water required at some future point in time is expected to exceed the hot water capacity of the tank. If so, the temperature setpoint may be increased. For example, suppose a HPWH system embodying this rules-based approach 700 has a capacity of 45 gallons when fully heated. Further suppose that hot water demand of 60 gallons is predicted between 7:00 and 8:00 AM on a weekday morning-a reasonably short period of time such that recovery will be insufficient. The Boolean/Lookup Controller 701 would calculate this difference and increase the setpoint temperature to, say, 140° F. to provide sufficient hot water during the the 7:00 to 8:00 AM period. This setpoint change would be done sufficiently far in advance so that the water could be heated efficiently (e.g., approximately six to eight hours or more in advance). Those skilled in the art to which the disclosure belongs that further rules could be implemented to alter this setpoint calculation to account for periods of high energy prices, high solar irradiance, etc. Similarly, the predictive control for compressor speed settings may implemented via a multidimensional lookup table, in which the input variables comprise the current tank temperature (available from a combination of lower and upper thermostat sensors (107 and 109, respectively), the target tank temperature, the air source temperature and humidity (available from an optional sensor (not shown), calculations on recent evaporator 115 operation utilizing information available in the primary controller, a localized weather forecast (not shown) or other sources that will be evident to one skilled in the art of the present disclosure), and the duration of allowable heating (available from the resource usage prediction module 304). The output values stored in this lookup table include, but are not limited to: the compressor partial load setting and the duration for which each setting shall be maintained during the heating cycle. For example, given an average starting water temperature of 80° F. across the entire tank, a wet bulb air temperature of 64° F., and an allowable heating period of six hours, the compressor speed may be set to 50% for hour 1, 50% for hour 2, 30% for hour three, 30% for hour four, 30% for hour five, and 50% for hour six, with these values having been stored in the aforementioned multi-dimensional lookup table in the Boolean/Lookup Table Controller 701. The implementation of the disclosure with alternative methods for predictive control such as the ones described herein (Reinforcement Learning, rules and/or multi-dimensional lookup tables) is appreciated by and intended to be within the scope of this disclosure.

### General; Computer Systems; Networking

In an embodiment, a system includes one or more devices, including one or more hardware processors, that are configured to perform any of the operations described herein and/or recited in any of the claims.

In an embodiment, one or more non-transitory computer-readable storage media store instructions that, when executed by one or more hardware processors, cause performance of any of the operations described herein and/or recited in any of the claims.

Any combination of the features and functionalities described herein may be used in accordance with an embodiment. In the foregoing specification, embodiments have been described with reference to numerous specific details that may vary from implementation to implementation. Accordingly, the specification and figures are to be regarded in an illustrative rather than a restrictive sense. The sole and exclusive indicator of the scope of the disclosure, and what is intended by the Applicant to be the scope of the disclosure, is the literal and equivalent scope of the set of claims that issue from this application, in the specific form in which such claims issue, including any subsequent correction.

In an embodiment, techniques described herein are implemented by one or more special-purpose computing devices (i.e., computing devices specially configured to perform certain functionality). The special-purpose computing device(s) may be hard-wired to perform the techniques and/or may include digital electronic devices such as one or more application-specific integrated circuits (ASICs), field programmable gate arrays (FPGAs), and/or network processing units (NPUs) that are persistently programmed to perform the techniques. Alternatively or additionally, a computing device may include one or more general-purpose hardware processors programmed to perform the techniques pursuant to program instructions in firmware, memory, and/or other storage. Alternatively or additionally, a special-purpose computing device may combine custom hard-wired logic, ASICs, FPGAs, or NPUs with custom programming to accomplish the techniques. A special-purpose computing device may include a desktop computer system, portable computer system, handheld device, networking device, and/or any other device(s) incorporating hard-wired and/or program logic to implement the techniques.

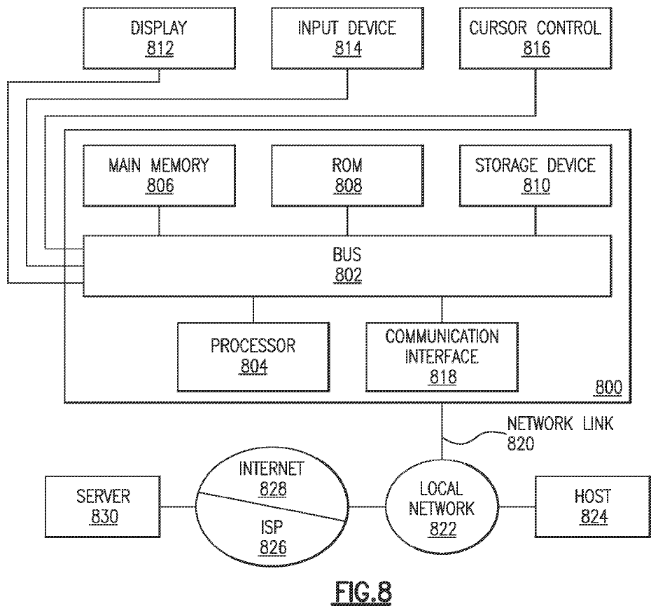

For example, FIG. 8 is a block diagram of an example of a computer system 800 according to an embodiment. Computer system 800 includes a bus 802 or other communication mechanism for communicating information, and a hardware processor 804 coupled with the bus 802 for processing information. Hardware processor 804 may be a general-purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in one or more non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a liquid crystal display (LCD), plasma display, electronic ink display, cathode ray tube (CRT) monitor, or any other kind of device for displaying information to a computer user. An input device 814, including alphanumeric and other keys, may be coupled to bus 802 for communicating information and command selections to processor 804. Alternatively or additionally, computer system 800 may receive user input via a cursor control 816, such as a mouse, a trackball, a trackpad, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane. Alternatively or additionally, computer system 800 may include a touchscreen. Display 812 may be configured to receive user input via one or more pressure-sensitive sensors, multi-touch sensors, and/or gesture sensors. Alternatively or additionally, computer system 800 may receive user input via a microphone, video camera, and/or some other kind of user input device (not shown).

Computer system 800 may implement the techniques described herein using customized hard-wired logic, one or more ASICs or FPGAs, firmware, and/or program logic which in combination with other components of computer system 800 causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. Alternatively or additionally, hard-wired circuitry may be used in place of or in combination with software instructions.

The term “storage media” as used herein refers to one or more non-transitory media storing data and/or instructions that cause a machine to operate in a specific fashion. Such storage media may include non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape or other magnetic data storage medium, a CD-ROM or any other optical data storage medium, any physical medium with patterns of holes, a RAM, a programmable read-only memory (PROM), an erasable PROM (EPROM), a FLASH-EPROM, non-volatile random-access memory (NVRAM), any other memory chip or cartridge, content-addressable memory (CAM), and ternary content-addressable memory (TCAM).

A storage medium is distinct from but may be used in conjunction with a transmission medium. Transmission media participate in transferring information between storage media. Examples of transmission media include coaxial cables, copper wire, and fiber optics, including the wires that include bus 802. Transmission media may also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer may load the instructions into its dynamic memory and send the instructions over a network, via a network interface controller (NIC), such as an Ethernet controller or Wi-Fi controller. A NIC local to computer system 800 may receive the data from the network and place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line.

As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822, and communication interface 818.

The received code may be executed by processor 804 as it is received, and/or stored in storage device 810, or other non-volatile storage for later execution.

In an embodiment, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (for example, a request to execute a particular application and/or retrieve a particular set of data). A server process responds by executing the requested service and/or returning corresponding data.

A computer network may be a physical network, including physical nodes connected by physical links. A physical node is any digital device. A physical node may be a function-specific hardware device. Examples of function-specific hardware devices include a hardware switch, a hardware router, a hardware firewall, and a hardware NAT. Alternatively or additionally, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (for example, a physical network). Each node in an overlay network corresponds to a respective node in the underlying network. Accordingly, each node in an overlay network is associated with both an overlay address (to address the overlay node) and an underlay address (to address the underlay node that implements the overlay node). An overlay node may be a digital device and/or a software process (for example, a virtual machine, an application instance, or a thread). A link that connects overlay nodes may be implemented as a tunnel through the underlying network. The overlay nodes at either end of the tunnel may treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources may be shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, a system supports multiple tenants. A tenant is a corporation, organization, enterprise, business unit, employee, or other entity that accesses a shared computing resource (for example, a computing resource shared in a public cloud). One tenant (through operation, tenant-specific practices, employees, and/or identification to the external world) may be separate from another tenant. The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used. In an embodiment, each tenant is associated with a tenant ID. Applications implemented by the computer network are tagged with tenant ID's. Additionally or alternatively, data structures and/or datasets, stored by the computer network, are tagged with tenant ID's. A tenant is permitted access to a particular application, data structure, and/or dataset only if the tenant and the particular application, data structure, and/or dataset are associated with a same tenant ID. As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants. A subscription list may indicate which tenants have authorization to access which applications. For each application, a list of tenant ID's of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels may be used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

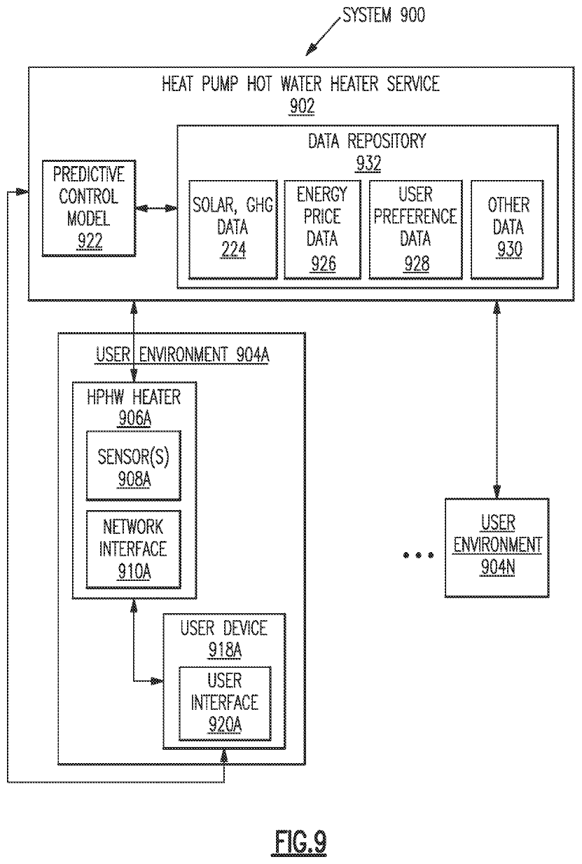

FIG. 9 is a block diagram of an example of a system 900 architecture according to aspect and embodiments of this disclosure. In an embodiment, the system 900 may include more or fewer components than the components illustrated in FIG. 9. The components illustrated in FIG. 9 may be local to or remote from each other. The components illustrated in FIG. 9 may be implemented in software and/or hardware. Each component may be distributed over multiple applications and/or machines. Multiple components may be combined into one application and/or machine. Operations described with respect to one component may instead be performed by another component.

As illustrated in FIG. 9, the system includes a heat pump hot water (HPHW) heater service 902 and one or more user environments 904A, 904N. Each user environment 904A, 904N refers to a distinct physical location. For example, two or more user environments 904A, 904N may be in different buildings (e.g., homes, offices, etc.). Alternatively or additionally, two or user environments 904A, 904N may be in different locations in the same building (e.g., in different rooms and/or different locations in the same room).

A user environment 904 may include heat pump hot water (HPHW) heater system 906A. Various embodiments of a HPHW heater system 906A have been described herein. An HPHW heater system 906A may be configured to perform operations to control heating of the heat pump hot water heater. One or more operations performed by the HPHW heater system 906A may be directed by any of the predictive controllers as described herein. In some embodiments, based on the results of predictive control, the heat pump hot water service 902 periodically provides updates to the HPHW heater system 906A.

A HPHW heater system 906A may be configured as described herein to heat hot water according to any or all of user preferences and optimizing economic efficiencies. A HPHW heater system 906A may include one or more sensors 908A to continuously collect data from the environment around the HPHW heater system 906A; and/or sending data (e.g., sensor data, analysis results, and/or other data) to the heat pump hot water heater service 902.

The HPHW heater system 906A and heat pump hot water heater service 902 may be components of a connected system configured to heat with a heat pump hot water heater system. Different user environments 904A, 904N may include different configurations of HPHW heater systems 904A-904N.

A HPHW heater system 906A-N each may include respective network interfaces 910A, that allow the devices to communicate with other devices over Ethernet, Wi-Fi, Bluetooth, Zigbee, etc. The HPHW heater systems 906A-N each may be configured to communicate with the HPHW service 902, for example, over an Internet connection. Alternatively or additionally, the HPHW heater systems 906A-N may be configured to communicate with each other, for example, over local network in the user environment 904A that both of the devices have joined. In some embodiments, the HPHW heater systems 906A-N may be configured to communicate with the HPHW service 902 over the Internet and with each other over a local connection (e.g., a local Wi-Fi network, Bluetooth, etc.).

In an embodiment, a HPHW service 902 includes a data repository 932 configured to store data used to control HPHW heater systems 906A-N in the user environments 904A, 904N. A data repository 932 may include any type of storage unit and/or device (e.g., a file system, database, collection of tables, or any other storage mechanism) for storing data. A data repository 932 may include multiple different storage units and/or devices. The multiple different storage units and/or devices may or may not be of the same type or located at the same physical site. Further, a data repository 932 may be implemented or may execute on the same computing system as one or more other components of the system 900. A data repository 932 may be implemented or executed on a computing system separate from one or more other components of the system 900. A data repository 932 may be logically integrated with one or more other components of the system 900. A data repository 932 may be communicatively coupled to one or more other components of the system 900 via a direct connection or via a network. In FIG. 9, a data repository 932 is illustrated as storing various kinds of information. Some or all of this information may be implemented and/or distributed across any of the components of the system 900. However, this information is illustrated within the data repository 932 for purposes of clarity and explanation.

Data stored in the data repository 932 may include, for example: regional data 924 including one or more of solar data and GHG emissions data, as has been described herein, in which the user environments 904A, 904N may be located. To obtain regional data 924, the HPHW heater service 902 may be configured to access one or more third-party services (not shown) such as a weather service, a solar system, a GHG system, and/or other third-party service that provides data relevant to the particular region; energy price data 926; user preference data 928 including user device profiles (e.g., models and configuration details of heat pump hot water heaters and/or other devices used in the different user environments 904A, 904N), locations,, etc.; and other data 930 including, for example, historical usage data 930 including data gathered from HPHW heater systems 906A-N, providing a history of heat pump hot water heater conditions in the user environments 904A, 904N. Historical data 930 may also include historical user-supplied data such as subjective evaluations of heat pump hot water heater comfort, user experience feedback, etc.

According to aspects and embodiments it is appreciated that to control the operation of HPWH heater systems 906A-N in the user environments 904A, 904N, the heat pump hot water service 902 may be configured to train a machine learning model (Reinforcement Learning (RL) or otherwise), instead of using a predictive controller 922, using data from the data repository 932. In general, machine learning allows the heat pump hot water service 902 to learn from past experiences, to better control other devices in the system 900 for heat pump hot water heating outcomes. For example, the heat pump hot water service 902 may continuously store data from one or more HPHW heater systems 906A-N and use machine learning to analyze the data. Based on the results of machine learning, the heat pump hot water service 902 may be configured to send user-and/or heat pump water heater specific instructions to one or more HPHW heater systems 906A-N.

The heat pump hot water service 902 may be configured to continuously receive diagnostic data from one or more HPHW heater systems 906A-N. The heat pump hot water service 902 may be configured to analyze the diagnostic data (e.g., using machine learning). Based on the results of analyzing the diagnostic data, the heat pump hot water service 902 may be configured to determine the status of each individual unit for maintenance and support, and/or generate one or more alerts when user intervention is needed with respect to a unit.

The heat pump hot water service 902 may be configured to provide data to one or more user interfaces, such as the user interface 920A of user device 918A. Such data may include, for example, reports e.g., device statuses, which may include monitoring limits with respect to power usage, etc., alerts, etc.

In some embodiments, one or more operations described herein as being performed by the heat pump hot water service 902 may be performed by the HPHW heater systems 906A-N. HPHW heater systems 906A-N may be configured to perform machine learning for an individual user, within the user environment 904A and/or in communication with other devices in the same local network.

In an embodiment, a system 900 such as that illustrated in FIG. 9A simplifies maintenance efforts while minimizing user interaction. Information from the heat pump hot water cycle may be fed into an algorithm that learns from the available data, adjusts device behavior, and optimizes hot water heating for each HPHW heater systems 906A-N automatically. Because user environments 904A, 904N do not need to be physically collocated, data can be collected in parallel from multiple sources. Collecting data from multiple sources increases the robustness of the data set feeding machine learning, while simplifying the user experience. This data can be applied to any machine in the system 900, regardless of form factor or location. Because user effort is reduced, the barrier to entry is as well. This means that inexperienced users can contribute to the system 900, with improved initial results, leading to a virtuous cycle and increased usership.

A user environment 904A may include one or more user devices 918A, such as a smartphone, tablet, laptop computer, desktop computer, special-purpose computing device, or other kind of device having a user interface 920A. A user device 918A may be configured to present information about the HPHW heater systems 906A-N in the user environment 904A in the user interface 920. Because the heat pump hot water heater management service 902 has access to information from multiple user environments 904A, the reports may include comparative data. Alternatively or additionally, a user device 918A may be configured to communicate directly (e.g., over a local network) with HPHW heater systems 906A-N, to obtain heating information and/or control operation of those device(s). For example, the user device 918A may include instructions for turning on and shutting off the various heating elements and compressors of the HPHW heater systems 906A-N, and/or controlling other physical functions of the device(s). Reporting and other functionality may be accessible in the user device 918A via user-installed software such as an application or “app.” Alternatively or additionally, the user interface 920A may be a web browser configured to access one or more web pages generated by the heat pump hot water heater service 902.

In general, a user interface 920A refers to hardware and/or software configured to facilitate communications between a user and a user device 918A. A user interface 920A renders user interface elements and receives input via user interface elements. A user interface 920A may be a graphical user interface (GUI), a command line interface (CLI), a haptic interface, a voice command interface, and/or any other kind of interface or combination thereof. Examples of user interface elements include checkboxes, radio buttons, dropdown lists, list boxes, buttons, toggles, text fields, date and time selectors, command lines, sliders, pages, and forms. Different components of a user interface 920A may be specified in different languages. The behavior of user interface elements may be specified in a dynamic programming language, such as JavaScript. The content of user interface elements may be specified in a markup language, such as hypertext markup language (HTML), Extensible Markup Language (XML), or XML User Interface Language (XUL). The layout of user interface elements may be specified in a style sheet language, such as Cascading Style Sheets (CSS). Alternatively or additionally, aspects of a user interface 920A may be specified in one or more other languages, such as Java, Python, Perl, C, C++, and/or any other language or combination thereof.

One or more components of the system 900 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

Those with ordinary skill in the art to which this disclosure belongs will understand that while the embodiments disclosed herein describe heating water for domestic uses, the same disclosure applies to heating or cooling water or another fluid for space conditioning, process applications, and other similar processes. Those with ordinary skill in the art to which this disclosure belongs will recognize that heat pump systems which provide both domestic hot water and space conditioning via heating and/or cooling a stored fluid are commercially available today, further illustrating that this disclosure applies to all of these applications.

Although the present disclosure has been illustrated and described herein with reference to embodiments and specific examples thereof, it will be readily apparent to those ordinary skill in the art that other embodiments and examples may perform similar functions and/or achieve like results. All such equivalent embodiments are within the spirit and scope of the present disclosure, are contemplated hereby, and are intended to be covered by the following claims.

1.-92. (canceled)

93. A method for heating fluid with a heat pump system configured to achieve user preferences, the method comprising:
receiving information including heat pump system information, a temperature of the heated fluid, and input information including user preferences;
determining, with a controller and responsive to the received information, preferred settings information including one or both of the preferred fluid temperature set points and preferred variable compressor speed set points;
continually determining with the controller the preferred settings information and heating the fluid in response to the preferred settings information so as to continually provide the output fluid from the heat pump system according to the received information; and
mixing of the output fluid with fluid from a fluid inlet so as to control a temperature of the output fluid from the heat pump system.

94. The method of claim 93, further comprising further receiving any of energy price information, solar information, and GHG intensity information.

95. The method of claim 94, wherein the controller provides the preferred settings information to optimize any one of or any combination of user comfort, cost reduction, greenhouse gas emissions reduction, and distributed energy system synchronization.

96. The method of claim 94, wherein the user can provide instructions to not use any or all of the solar information, the GHG intensity information, and the energy price information to determine the preferred settings information.

97. The method of claim 94, wherein the solar information includes one or both of prediction information or a real-time information.

98. The method of claim 93, wherein the controller provides the preferred settings information to optimize any one or both of the user preferences and economic efficiencies.

99. The method of claim 93, wherein the controller controls one or both of the variable speed compressor, fluid temperature setpoint, and one or more heating elements to heat the fluid according to the preferred settings information.

100. The method of claim 93, wherein the heat pump system information includes fluid flow information, and wherein the controller uses the fluid flow information to further determine future fluid demand information so as to determine the preferred settings information.

101. The method of claim 100, wherein the input information further includes historical hot fluid usage data and the preferred settings information is additionally determined in response to the historical hot fluid usage data.

102. The method of claim 93, wherein the input information further includes weather-related information and wherein the controller provides the preferred settings information additionally in response to the weather-related information, and wherein the user can provide instructions to not use the weather-related information to determine the preferred settings information.

103. The method of claim 93, wherein the user preferences include periods of time during which heat pump operation is not desirable.

104. The method of claim 93, wherein receiving input information further includes receiving any of inlet fluid temperature information and fluid flow information.

105. A heat pump system comprising:
a fluid storage tank, a fluid inlet, a fluid outlet, at least one temperature sensor on the fluid storage tank, a heat pump sub assembly comprising a first heat exchanger in thermal communication with any of air, fluid and ground from and to which heat is being transferred, a second heat exchanger in thermal communication with the fluid storage tank, a variable speed compressor, and a refrigerant heat transfer medium;
a mixing valve connected to the fluid outlet configured so as to control a temperature of the fluid exiting the mixing valve by mixing the fluid from the fluid outlet with fluid from the fluid inlet;
a database having an input for receiving information including heat pump system information, temperature information of the temperature of the fluid, and input information including user preferences, and for storing the received information in the database;
a controller that receives the received information and that continually determines at least one or both of the preferred settings information including the preferred fluid temperature set points and preferred variable compressor speed set points.

106. The heat pump system of claim 105, the input information further includes any or all of energy price information, solar system production information, and GHG intensity information.

107. The heat pump system of claim 106, wherein the controller is further configured to provide the preferred settings information to optimize any of or any combination of user comfort, cost reduction, greenhouse gas emissions reduction, and distributed energy system synchronization.

108. The heat pump system of claim 106, wherein the controller is configured so that the user can provide instructions to not use any or all of the energy price information, the solar information, and the GHG intensity information to determine the preferred settings information.

109. The heat pump system of claim 106, wherein the solar information includes one or both of output prediction information or a real-time output signal from a home solar system or other data source.

110. The heat pump system of claim 105, wherein the controller is configured to provide the preferred settings information to one or both of optimize the user preferences and economic efficiencies.

111. The heat pump system of claim 105, wherein the controller controls any one of or a combination of the variable speed compressor, the fluid temperature setpoint, and the one or more heating elements to heat the fluid according to the received information.

112. The heat pump system of claim 105, further comprising a fluid flow meter that provides fluid flow information, and wherein the controller uses the fluid flow information to provide the usage prediction information, and wherein the controller is further configured to determine future fluid demand information so as to determine the preferred settings information.

113. The heat pump system of claim 105, wherein the input information further includes weather-related information and wherein the controller is further configured to provide the preferred settings information additionally in response to the weather-related information, and wherein the controller is further configured so that the user can provide instructions to not use the weather-related information to determine the preferred settings information.

114. The heat pump system of claim 105, wherein the input information further includes historical hot fluid usage data and the preferred settings information is additionally determined in response to the historical hot fluid usage data.

115. The heat pump system of claim 105, wherein the user preferences include periods of time during which heat pump operation is not desirable.

116. The heat pump system of claim 105, wherein the input information further includes receiving any of inlet fluid temperature information, fluid flow information, and present usage information.

117. The heat pump system of claim 116, wherein the present usage information includes any of current fluid temperature, volume of the fluid, and volumetric flow rate.
